(19) United States
(12) Patent Application Publication
(10) Pub. No.: US 2026/0030205 A1
(43) Pub. Date: Jan. 29, 2026

(54) FOLDER SUMMARIZATION USING GENERATIVE MODELS

(71) Applicant: GOOGLE LLC, Mountain View, CA (US)

(72) Inventors: Michael Colagrosso, Arvada, CO (US); Yanqiu Wang, Jersey City, NJ (US); Jee Won Kim, Mountain View, CA (US); Brandon Vargo, Boulder, CO (US); Michael Garrett Sloan, Boulder, CO (US); Remy Burger, Boulder, CO (US); Zach Dicklin, Lafayette, CO (US)

(21) Appl. No.: 18/781,681

(22) Filed: Jul. 23, 2024

(51) Int. Cl. G06F 16/16

(52) U.S. Cl. CPC G06F 16/16

(57) ABSTRACT

Implementations relate to leveraging a generative model in summarizing a folder having different files and/or sub-folder(s). Various types of information associated with the folder, one or more files within the folder, user metadata associated with a user that requests summarization of the folder, and/or other types of information can be utilized to generate a folder summary request. The folder summary request can be processed using the generative model, to generate a model output reflecting a folder summary. The folder summary request can include one or more instructions that prompt the generative model, so that the folder summary generated for the folder using the generative model can include, for instance, an overview of the folder, key topics of the folder, and/or key files of the folder. The folder summary can also vary in dependence on the user (e.g., a first-time user vs. a frequent user frequently visits the folder, etc.).

### BACKGROUND

Various generative models (e.g., large language models, “LLMs”) have been developed to process user input (e.g., typed input, audible input, etc.), to generate output that reflects generative content that is responsive to the user input. For example, generative models can process natural language content recognized from an audible input (e.g., “could you explain general relativity”), to generate model output reflecting content (e.g., “General relativity is the geometric theory of gravitation published in 1915 . . . ”) that is responsive to the audible input. As another example, generative models have been trained to process natural language content (such as a dialogue transcribed from a 30-min group meeting, one or more product reviews, etc.) to generate a succinct summary of key content of the natural language content.

Filesystems allow users to organize files (e.g., documents, media content, images, databases, etc.) into hierarchies of folders in virtually any manner they see fit. However, different users and/or organizations may organize files and folders differently. Additionally, users and/or organizations may not be diligent and/or consistent in organizing and/or managing how files and folders are arranged, leading to disorganized filesystems where finding individual files can be difficult, and understanding contents of individual folders, and/or folder hierarchies more generally, can be challenging. This forces a user to manually review files and information (e.g., working emails) associated with folders, which can take significant time. Moreover, in cases where the user is given limited time to review folders, frequently launching, accessing, and/or exiting different applications (or platforms) to review the various types of files within the folders can cause intensive consumption of computational resources, network resources, and battery resources.

### SUMMARY

Implementations disclosed herein relate to leveraging various types of generative models, e.g., a large language model (LLM), a vision language model (VLM), a visual question answering (VQA) model, a diffusion model, etc., to generate a summary of a folder (e.g., a dynamic folder that includes various different types of files and that is accessed and/or updated by one or more users). In various implementations, the generated summary can summarize key content in the folder, in dependence on a role (or other metadata) of a user that is authorized to access the folder and that requests the summary. Such a generated summary can enable the user to have a comprehensive understanding of the folder, and different summaries of the same folder can be provided for different users. For example, a first user of the folder who accesses the folder for the first time can be presented with a summary listing key topics and/or key files of the folder. A second user of the folder who frequently accesses or edits the folder can be presented with a summary including at least a portion summarizing the most recent updates to the folder, in addition to (or instead of) the key topics and/or key files. The present disclosure, however, is not limited to descriptions herein.

In various implementations, a method implemented using one or more processors is provided. The method includes: determining a plurality of files stored within a folder; selecting, from the plurality of files stored within the folder, a subset of files to represent the folder; and generating a folder summary request based at least on file content of the subset of files. In some implementations, optionally, determining the plurality of files stored within the folder can be performed in response to receiving a request (e.g., a user request or a system request) for folder summarization.

For instance, in some implementations, optionally, determining the plurality of files stored within the folder can be performed in response to receiving a user input for folder summarization, where the user input can be a spoken request, a typed request, or other types of input/request. In some implementations, optionally, determining the plurality of files stored within the folder can be performed in response to receiving a system request for folder summarization, where the system request can be generated automatically. In some implementations, a system for performing the method can determine the folder to be summarized based on the user input (or the system request) for folder summarization, and/or based on contextual information (such as time, or other metadata) associated with the user input (or the system request).

In some implementations, the folder summary request is in natural language and includes an instruction that instructs to generate a plurality of portions of a folder summary for the folder.

In some implementations, the method further includes: processing the folder summary request, using a generative model, to generate a model output reflecting the folder summary; and causing the folder summary to be rendered (e.g., in response to the user input for folder summarization). In some implementations, the plurality of portions of the folder summary for the folder includes an overview portion that provides an overview of the folder and a key topic portion that provides one or more key topics determined from the subset of files.

In some implementations, selecting, from the plurality of files stored within the folder, the subset of files to represent the folder can include: generating a content embedding for each file from the plurality of files, where the content embedding of a respective file numerically represents content of a respective file from the plurality of files; grouping, based on the content embedding for each file, the plurality of files into a plurality of file groups, wherein each file group includes one or more files having a similarity satisfying a similarity threshold; ranking the plurality of file groups; and selecting one or more top ranked file groups to form the subset of files selected from the plurality of files. In some implementations, given that the respective file being a text file, the content embedding of the text file is generated based on processing word content of the text file using a text encoder. In some implementations, given that the respective file being an image, the content embedding of the respective file (e.g., the image) is generated based on processing pixels of the image using an image encoder. The way the content embedding of the respective file is generated, however, is not limited herein.

In some implementations, in case the respective file is a text file, the content embedding of the respective file can be generated based on processing a file summary (instead of the word content in its entirety) of the respective file using a text encoder. In some implementations, the file summary of the respective file is extracted from the respective file, or is generated based on processing file content (e.g., the word content) of the respective file using the generative model or an additional generative model (e.g., trained to summarize a text file, etc.).

In some implementations, in case the respective file is an image, the content embedding of the respective file (e.g., the image) can, alternatively, or additionally, be generated based on processing text description(s) determined for the image. The text descriptions for the image can include, for instance, a caption of the image generated using an image-captioning model, a VLM, a VQA, etc. The text descriptions for the image can additionally, or alternatively, include, for instance, one or more characters present in the image and recognized from the image using an optical character recognition (OCR) model.

In some implementations, the method further includes: determining metadata associated with a user of the user input in response to receiving the user input. In some implementations, generating the folder summary request based at least on the file content of the subset of files includes: generating the folder summary request based further on the metadata associated with the user of the user input/request for folder summarization. In some implementations, the rendered folder summary varies in dependence on the metadata associated with the user of the user input for folder summarization.

In some implementations, the rendered folder summary includes a summary for one or more updates to the folder within a predefined period of time, in addition to the overall summary and in addition to the one or more key topics, based on the metadata associated with the user indicating that a frequency of the user in visiting (and/or editing) the folder satisfies a frequency threshold (e.g., 5 times during past week).

In some implementations, the plurality of portions of the folder summary for the folder further identifies one or more key files from the folder. In some implementations, the one or more key files identified in the folder summary are respectively associated with the one or more key topics. However, this is not required. For instance, the one or more key files can include a particular file (e.g., text file, image, etc.) having a pending action associated with the user of the user input/request for the folder summarization. The pending action for the user to be performed can be, for instance, a pending review action that requires the user of the request for folder summarization to review a reply from another user to a comment left by the user to the particular file. The pending action, as another example, can be an editing request that requests the user of the request for folder summarization to edit or review the particular file. Descriptions of the pending action(s), however, are not limited herein.

In some implementations, the method further includes: determining metadata associated with user activities of one or more users having access to the folder, where generating the folder summary request is further based on the user activities of the one or more users.

In some implementations, the method further includes: determining content associated with one or more of the user activities that alter one or more files within the folder, where the plurality of portions of the folder summary for the folder further include one or more actions suggested for a user of the user input based on the one or more of the user activities. The user activities can be associated with the user that requests for folder summarization and/or be associated with one or more additional users that have access to the folder.

In some implementations, the plurality of portions of the folder summary for the folder further include an overview summarizing an update to the folder within a predefined period of time before receiving the request (e.g., user input) for folder summarization.

In some implementations, the plurality of portions of the folder summary further includes the overview summarizing the update to the folder based on the user input requesting an update of the folder. For instance, the user input may request summarizing one or more particular aspects (e.g., a special topic, a sub-folder, images, meeting notes, etc.) of the folder.

In some implementations, the plurality of portions of the folder summary further includes the overview summarizing the update to the folder, without the user input requesting an update of the folder.

In some implementations, selecting the subset of files to represent the folder is performed using a file selection model based at least on file content of the plurality of files within the folder and metadata associated with the folder.

In some implementations, the file selection model is a machine learning model trained to select one or more files from a given folder.

In some implementations, the file content of the subset of files include a file summary for each file from the subset of files.

In some implementations, the file summary for a respective file from the subset is generated based on processing the file content for the respective file, using the generative model or a different model.

The preceding is presented as an overview of only some implementations disclosed herein. These and other implementations are disclosed in additional detail later in this disclosure. By leveraging (e.g., training, fine-tuning, or prompt engineering, etc.) a generative model to summarize a folder, a summary of the folder can be presented to a user in an almost instant manner. The summary of the folder can be comprehensive and reflect key topics and/or key files the user needs to know, and can also vary in dependence on a role (or other metadata) associated with the user. This saves time and resources (e.g., computational resources, network resources, etc.) that would otherwise be consumed in cases where different applications or services are launched and executed for the user to manually review content of each file (or a large percentage of files) with the folder.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A illustrates a flowchart showing generation of a structured summary for a folder using techniques described in accordance with various implementations of the present disclosure.

FIG. 2B illustrates a user interface of a file storage application showing a shared folder, in accordance with various implementations of the present disclosure.

FIG. 2C illustrates a user interface of a file storage application showing a summary generated for the shared folder in FIG. 2B, in accordance with various implementations of the present disclosure.

FIG. 3A illustrates another example user interface of a file storage application showing a folder, in accordance with various implementations of the present disclosure.

FIG. 3B illustrates a user interface showing the usage of a virtual assistant in generating a folder summary for the folder in FIG. 3A, in accordance with various implementations of the present disclosure.

FIG. 3C illustrates an example user request for a folder summary for the folder in FIG. 3A/3B, in accordance with various implementations of the present disclosure.

FIG. 3D illustrates an example pop-up window showing a portion of a folder summary generated in response to the user request in FIG. 3C, in accordance with various implementations of the present disclosure.

FIG. 3E illustrates an example folder summary generated in response to the user request in FIG. 3C, with full content illustrated, in accordance with various implementations of the present disclosure.

FIG. 3F illustrates a folder summary showing unfolded source information with respect to FIG. 3E, in accordance with various implementations of the present disclosure.

FIG. 3G illustrates another example folder summary generated in response to the user request in FIG. 3C, with full content illustrated, in accordance with various implementations of the present disclosure.

FIG. 3H illustrates a folder summary showing unfolded source information with respect to FIG. 3G, in accordance with various implementations of the present disclosure.

FIG. 3I illustrates a further example folder summary generated in response to the user request in FIG. 3C, with full content illustrated, in accordance with various implementations of the present disclosure.

FIG. 3J illustrates a folder summary showing unfolded action information with respect to FIG. 3I, in accordance with various implementations of the present disclosure.

FIG. 3K illustrates an additional example folder summary generated in response to the user request in FIG. 3C, with full content illustrated, in accordance with various implementations of the present disclosure.

FIG. 3L illustrates a folder summary showing unfolded source information with respect to FIG. 3K, in accordance with various implementations of the present disclosure.

FIG. 3M illustrates an even further example folder summary generated in response to the user request in FIG. 3C, with full content illustrated, in accordance with various implementations of the present disclosure.

FIG. 3N illustrates a folder summary showing unfolded action information with respect to FIG. 3K, in accordance with various implementations of the present disclosure.

FIG. 4 depicts an example of a method for summarizing a folder in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

Conventionally, when given a folder shared by others (e.g., co-workers, etc.), a user may scan the folder by opening each file within the folder. However, when the folder contains a large quantity of files or has several layers of sub-folders, it may be tedious for the user to selectively open and review certain files. This is time-consuming, and also resource intensive, especially when multiple applications or services are launched for the user to access some of the files within the folder. The user also bears a high risk of missing important pieces of information if only given limited amount of time to review the folder when the folder includes many files.

Advances in generative models (e.g., LLM(s)) can enable processing of natural language content to generate a short summary for the natural language content. However, this is often limited to short articles, or other types of content having limited length. Processing all files within a folder to generate a folder summary may cause the LLM to fail to operate (depending on maximum context length an LLM handles) or can cause significant delay in generating a folder summary. Generating a folder summary can also be challenging when the folder includes a large quantity of files, includes sub-folders, and/or includes different types of files (such as an image and a spreadsheet). Moreover, a folder may contain a large number of legacy files that are less germane to the folder's current purpose, but may contain relatively fewer files that are more recent and/or germane/relevant to the folder and/or to the user accessing the folder.

Accordingly, there is a need for an approach that selects a subset of files from a folder that accurately represent the relevant and/or timely contents of the folder, so that a folder summary can be generated by processing this subset of files using the generative model. In some cases, the folder summary should reflect key topics and/or updates to the folder, which may vary depending on the context of a user that requests a summary of the folder's contents.

Implementations described herein leverage one or more generative models (e.g., an LLM trained to process natural language content, a multi-modal generative model, a VLM or VQA model, diffusion model, etc.), to automatically generate a folder summary. The folder summary may include, for instance, an overview (e.g., total number of files within the folder, brief textual summary of the content of the folder's files, etc.) of a folder, key topics determined for the folder, and/or links to key files of the folder. In some implementations, to generate the folder summary, a subset of files representing the folder can be selected (e.g., based on file clustering, user activities of a user that requests to summarize the folder, user activities of other users having access to the folder, and other information). A prompt (e.g., the aforementioned folder summary request) to the LLM can be generated based on the subset of files, metadata associated with the folder, metadata associated with all files with the folder or the selected subset, user metadata of one or more users, and/or a complex instructions that defines a structure of the folder summary, etc. The prompt can be processed using a generative model (e.g., the LLM) to generate the folder summary.

The generated folder summary can be different for a user accessing the folder for the first time and a user who frequently accesses the folder. For example, a folder summary for the user who frequently accesses the folder can include an additional summary for the updates to the folder (since the user's last-time visit, or since a default period of time, e.g., yesterday).

The generated folder summary can also reflect one or more actions suggested for a user that requests the folder summarization. For example, the one or more actions can include an action to review a reply to a comment the user made in a particular file within the folder.

In some implementations, the generative model may be a multimodal modal that is trained to process multiple modalities of data, such as text, imagery, audio, video, etc., and/or to generate multiple modalities of output. Such a multimodal generative model may be used, for instance, to generate a textual summary that not only summarizes text contained in a textual document, but that also summarizes imagery contained in the same or different documents, in digital images, videos, etc. Moreover, these summarizations may be textual, visual, audio, or any combination thereof.

For example, in a folder that contains multiple architectural drawings, each portraying a constituent part of a larger building, a request to summarize the folder's contents could yield a summary in the form of a synthesized architectural drawing of the entire building (e.g., with missing portions interpolated by the generative model). As another example, multiple textual documents (e.g., each including a single chapter) and/or pictures contained in a folder that collectively tell a story could be summarized, e.g., in a condensed summary of the story, or even in a summary animation that portrays the plot of the story.

In some implementations described herein, one or more machine learning (ML) models are leveraged to select a subset of files representing a folder. The selected subset of files can be clustered into different clusters each corresponding to a key topic for the folder, and one or more files can be selected as key files from each cluster to be processed (e.g., using the aforementioned LLM) to generate an overview for the folder, to be included as part of the folder summary. The summary folder can therefore include not only an overview of the folder, but also key topics and/or key files of the folder. Some implementations described herein also allow customization of the folder summary based on metadata of a user that requests the folder summarization. This saves time and resources the user otherwise would need to afford to grasp the key information from a given folder.

By leveraging (e.g., training, fine-tuning, or prompt engineering, etc.) a generative model (and/or other models) to summarize a folder, a summary of the folder can be presented to a user in an almost instant manner. The summary of the folder can be comprehensive and reflect key topics and/or key files the user needs to know, and can also vary in dependence on a role (or other metadata) associated with the user. This saves time and resources (e.g., computational resources, network resources, etc.) that would otherwise be consumed in cases where different applications or services are launched and executed for the user to manually review content of each file (or a large percentage of files) with the folder.

It is noted that, the folder can be a personal folder, a public folder, or a folder shared between multiple users for access or edit. The folder can include different types of files (e.g., image, document, spreadsheet, etc.) and can include sub-folders. The folder summary can be generated automatically (e.g., per day to show a summary of updates to the folder since yesterday), or can be generated based on a user requesting for folder summarization. The folder summary can have a structure including an overview, key topics, and links to key files, and content (e.g., key topics, key files, etc.) can vary in dependence on metadata (e.g., role, activity, level of access, etc.) associated with a user that requests for folder summarization.

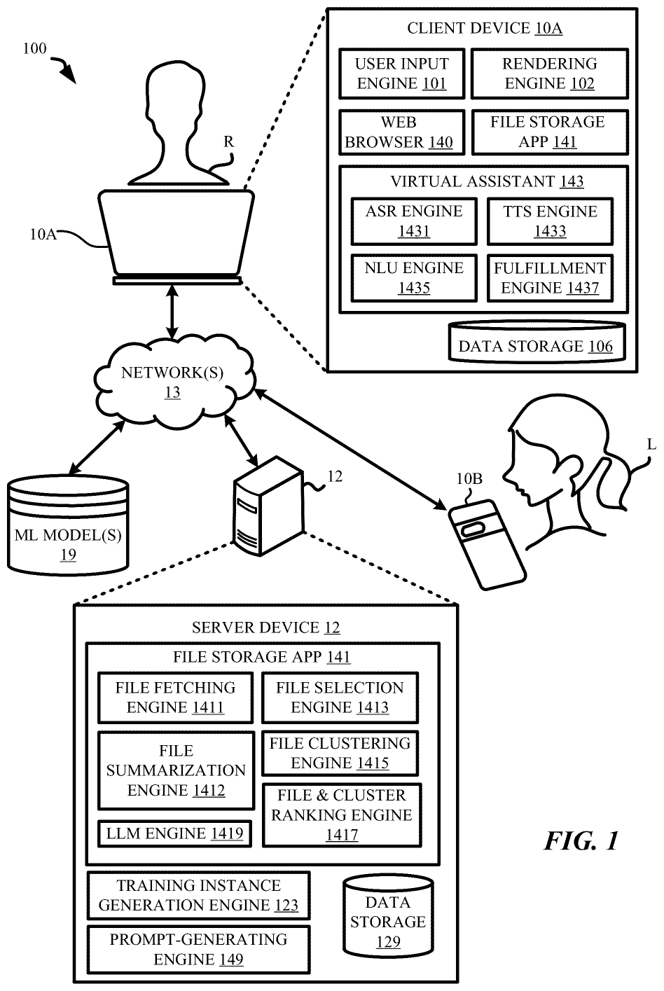

FIG. 1 is a block diagram of an example environment 100 that demonstrates various aspects of the present disclosure, and in which implementations disclosed herein may be implemented. As shown in FIG. 1, the environment 100 can include a first client computing device 10A (“first client device”) that is in communication with a server computing device 12 (“server device”). The client computing device 10A can be in communication with the server computing device 12, via one or more networks 13. The one or more networks 13 can include, for example, a local area network (LAN), a wide area network (WAN) such as the Internet, and/or any other appropriate network(s). In some implementations, the client computing device 10A (and/or the server computing device 12) can be in communication with one or more machine learning (ML) models 19, via the one or more networks 13. In some implementations, the example environment 100 can, additionally, or alternatively, include a second client computing device 10B that is in communication with the server computing device 12 and/or the first client computing device 10A. The second client computing device 10B can be of the same type, or of a different type, with respect to the first client computing device 10A. In some implementations, descriptions of the first client computing device 10A are applicable to the second client computing device 10B, and repeated descriptions are omitted for the sake of brevity.

In some implementations, the environment 100 can be an office environment, a home environment, a lab environment, or any other applicable environment, and the environment 100 can include additional client device(s) (or additional server device(s)) that connect to the one or more networks 13. In some implementations, the first client computing device 10A (or the second computing device 10B) can be, for example, a desktop computing device, a laptop computing device, a tablet computing device, a mobile phone computing device, a computing device of a vehicle (e.g., an in-vehicle entertainment system), a smart appliance (e.g., an interactive speaker), and/or a wearable apparatus that includes a computing device (e.g., glasses having a computing device, a smart watch, a virtual or augmented reality computing device), and the present disclosure is not limited thereto.

In various implementations, the first client computing device 10A (or 10B) can include a user input engine 101 that is configured to detect user input provided by a user (e.g., user R or user L) of the first client computing device 10A (or 10B). The user input may be provided by the user using one or more user interface input devices, such as a keyboard, a touch screen, a microphone, etc. The user input can be typed input, touch input, audible input, or any other applicable type of input. For example, the first client computing device 10A can be equipped with a keyboard to receive typed input, and/or a mouse (or one or more hardware buttons) to receive a user click that selects one or more graphical user interface (GUI) elements that is rendered visually at a user interface of the first client computing device 10A. The typed input (e.g., “show me presentations from last year”) can be received, for instance, via an input field of a graphical user interface (GUI) of an application. Additionally, or alternatively, the first client computing device 10A can be equipped with one or more microphones that capture audio data, such as audio data capturing spoken utterances of the user and/or other sounds in a surrounding environment of the first client computing device 10A. Optionally, the audio data capturing the spoken utterances can be received in response to a user selecting an icon indicating capturing/recording of audio data. Additionally, or alternatively, the first client computing device 10A can be equipped with one or more vision components that are configured to capture vision data corresponding to images and/or movements (e.g., gestures) detected in a field of view of one or more of the vision components. Additionally, or alternatively, the first client computing device 10A can be equipped with one or more touch sensitive components (e.g., a stylus, a touch screen, a touch panel, etc.) that are configured to capture signal(s) corresponding to touch input that is directed to the first client computing device 10A.

In various implementations, the first client computing device 10A can include a rendering engine 102, and/or a data storage 106. In various implementations, the rendering engine 102 can be configured to provide content for audible and/or visual presentation to a user of the first client computing device 10A using one or more user interface output devices. For example, the first client computing device 10A can be equipped with one or more speakers that enable content (e.g., a notification sound) to be provided for audible presentation to the user via the first client computing device 10A. Additionally, or alternatively, the first client computing device 10A can be equipped with a display or projector that enables content (e.g., “The shared folder you select contains 229 documents, spreadsheets, and slides.”) to be provided for visual presentation to the user via the first client computing device 10A.

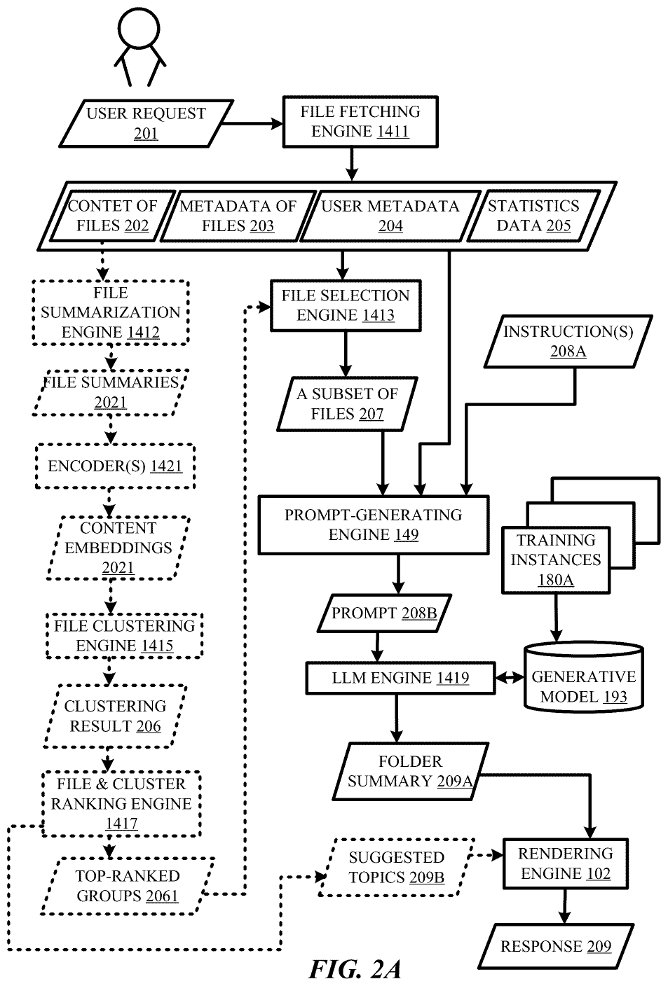

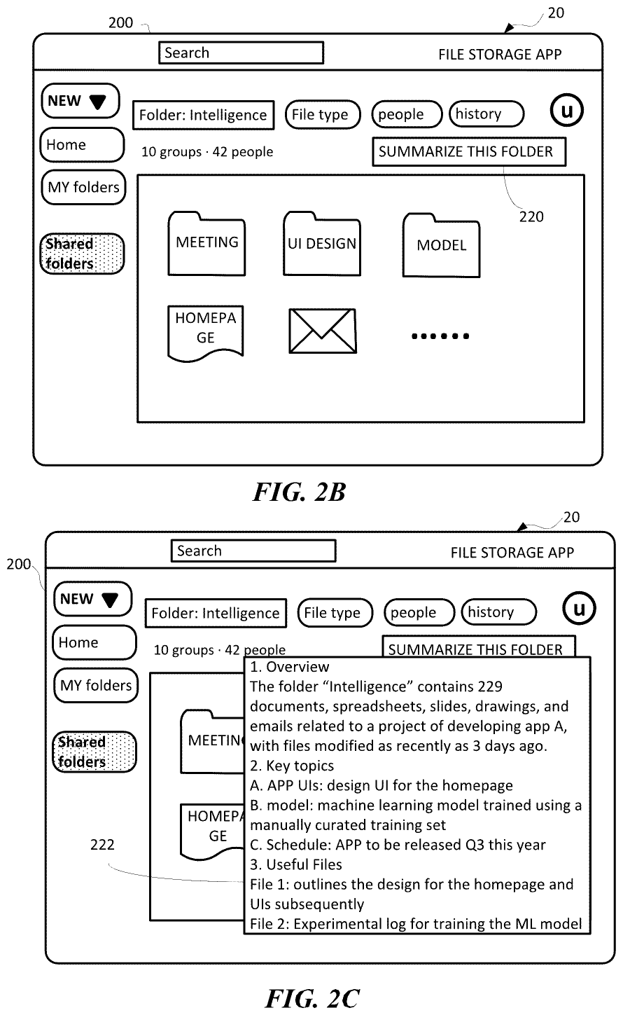

The data storage 106, and/or a data storage 129 at the server device 12, can store various types of files, folders, and/or other data. For instance, the data storage 106 of the first client computing device 10A can store metadata associated with the first client computing device 10A (or the second client computing device 10B), associated with the user (e.g., a user profile of user R, etc.), and/or associated with one or more applications stored at or accessible via the first client computing device 10A (e.g., user activities with respect to a file application). Additionally, or alternatively, in some implementations, the data storage 106 (or the data storage 129) can store a plurality of training instances (e.g., 180A in FIG. 2A) to train or fine-tune one or more of the ML models 19. In some implementations, the ML model(s) 19 can include a generative model 193 (see FIG. 2A). The generative model 193 can be, for instance, an LLM, VLM, VQA model, diffusion model, etc.

In some implementations, training (or fine tuning) of the generative model (e.g., 193) can be performed through supervised learning and/or reinforcement learning. The reinforcement learning can be, for instance, reinforcement learning from human feedback (“RLHF”) that incorporates human feedback into the training or fine-tuning of the LLM to align output of the LLM with human preferences. This can be implemented using a reward model trained based on human feedback. For instance, for a given user input and a plurality of responses responsive to the given user input, a human reviewer can indicate a preference (e.g., in the form of a scalar score) for each of the plurality of responses. In other words, the plurality of response for the given user input can be ranked in an order from highest human preference (indicated by a highest scalar score) to lowest human preference (indicated by a lowest scalar score). In some implementations, the scalar scores assigned by the human reviewer to the plurality of responses for the given user input can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score can be applied as a reward in the RLHF process, where a large value of the scalar score indicates a higher quality of a corresponding response more preferred by the human reviewer and a lower value of the scalar score indicates a higher quality of a corresponding response that is less preferred by the human reviewer. In some implementations, such given user input and the plurality of responses responsive to the given user input can be stored in the data storage 106 (or the storage 129) as one instance for training the reward model. In some implementations, a small quantity of instances can be manually curated and/or stored in the data storage 106 (or 129), to train the reward model.

In various implementations, the aforementioned one or more applications accessible via the first client computing device 10A can include a web browser 140 and/or a file storage application 141 that enables users to store and access files In some implementations, the file storage application 141 can be configured, for instance, to provide cloud-based storage services where file(s) uploaded by user R using a registered account of user R for the first storage application 140 are stored at one or more server devices (which can include the server computing device 12 and/or other server devices). In some implementations, the file storage application 141 can enable a user to create, access, manage, and/or share, with other user(s), one or more files accessible via the file storage application 141. In some implementations, additionally, or alternatively, the file storage application 141 can enable the user to create, access, manage (e.g., edit, delete, etc.), and/or share other content (e.g., one or more folders) accessible via the file storage application 141.

In some implementations, additionally, or alternatively, the file storage application 141 can enable the user to save one or more of the files accessible via the file storage application 141 locally (e.g., at the first client computing device 10A). The type, features, or functions of the file storage application 141, however, are not limited to descriptions herein. For example, in some implementations, the file storage application 141 can include additional functions, e.g., that enable a user to create various different types files (such as a spreadsheet, an image, or a presentation) using external tools or services (e.g., APIs for spreadsheet application, image-processing application, a presentation application, etc.). As another example, in some implementations, the file storage application 141 can be in the format of a software as a service (SaaS) application. As a further example, the file storage application 141 can include a function of summarizing one or more files (or one or more folders) that are stored (or shared) via the file storage application 141.

In some implementations, the file storage application 141 can be installed locally at the first client computing device 10A, and the user can access the file storage application 141 via the first client computing device 10A. In some implementations, additionally, or alternatively, a user can access the file storage application 141 via a website associated with the file storage application 141, e.g., using the aforementioned web browser. In some implementations, additionally, or alternatively, a user can access the file storage application 141 via a third-party application in communication with the file storage application 141. The present disclosure, however, is not limited thereto.

In various implementations, the file storage application 141 can include, or otherwise access, a file fetching engine 1411, a file selection engine 1413, and/or an LLM engine 1419. The file fetching engine 1411, the file selection engine 1413, and/or the LLM engine 1419 can be accessed, for instance, at the server computing device 12. In some implementations, the file fetching engine 1411, the file selection engine 1413, and/or the LLM engine 1419 can have local counterpart(s) at the first client computing device 10A (or the second client computing device 10B, etc.).

Given a folder (or a directory, etc.) storage at (or otherwise accessible) via the file storage application 141, the file fetching engine 1411 can be configured to fetch files stored within the given folder. Such fetched files can include, for instance, files stored within subfolders (if there is any) of the given folder. In some implementations, the given folder can be, for instance, a personal folder personal to user R. The user R may, for instance, manage or update the personal folder by adding, deleting, or editing file(s) with the given folder. The user R may also share the personal folder with one or more other users, so that the personal folder becomes a shared folder. In some implementations, the given folder may be a shared folder shared with the user R by another user, where the shared folder can be shared with a group of users that include the user R and the another user. The group of users (or an authorized portion thereof) may update the shared folder by adding, deleting, or editing file(s) with the shared folder, or changing other properties/settings, etc. In some implementations, the given folder can include one or more subfolders. The one or more subfolders, for instance, can respectively include one or more additional subfolders and/or file(s). In other words, the given folder or directory can be nested and/or have a complex hierarchy.

In some implementations, the file fetching engine 1411 can determine statistics data of a given folder, and metadata associated with the given folder. The statistics data of the given folder can include, for instance, a total number of files in the given folder, a quantity for each type of files (e.g., document, spreadsheet, image, etc.) in the given folder, and/or a total number of sub-folders (if any) in the given folder, etc. The metadata associated with the given folder can include, for instance, a most recent activity associated with the folder (e.g., most recent edit occurred 3 days ago), and/or an oldest activity associated with the folder (e.g., first file of the folder added 2 years ago), etc.

In some implementations, the file fetching engine 1411 can determine metadata associated with the folder (e.g., metadata associated with file(s) present within the folder). For instance, metadata associated with a respective file stored within the folder can include: a file identifier (e.g., file_1) of the respective file, a file name of the respective file, an address (e.g., path or link) of the respective file, a summary of the respective file, one or more activities (e.g., creation, modification, etc.) of the respective file, and/or one or more timestamps each associated with one of the one or more activities of the respective file.

In some implementations, the aforementioned one or more timestamps for a respective file can include, for instance, a first timestamp indicating a time (e.g., 10 days ago) at which the respective file was created and/or an identifier of a first user that creates the respective file. Optionally, the one or more timestamps for the respective file can further include a second timestamp indicating a time (e.g., 4 days ago) at which the respective file was updated and/or an identifier of a second user that updates the respective file. The second user can be the same as, or different from, the first user. Descriptions of the one or more timestamps, however, are not limited herein.

In some implementations, the metadata associated with the files in the folder can, additionally, or alternatively, include data indicating whether a respective file within the folder is private (e.g., no access by others other than a file creator), publicly shared (e.g., everyone can have access), shared with one or more particular users, etc.

In some implementations, the folder can be a shared folder, and the metadata associated with a respective file stored within the folder (e.g., the shared folder) can, additionally, or alternatively, include metadata associated with one or more users having access to the respective file. For instance, the metadata associated with a respective file can include: a list of user IDs (or other user identifier) respectively representing a user having access to the respective file, and/or a role (e.g., creator, top contributor, editor, read-only, manager, first-time user, etc.) of the each user having access to the respective file, etc. The metadata associated with a respective file stored within the folder can, additionally, or alternatively, include: user activities (e.g., editing two days ago, etc.) for each user having access to the respective file.

In some implementations, additionally, or alternatively, the metadata associated with the folder can include data (e.g., user ID, nickname, etc.) identifying each user having access to the folder. In some implementations, the metadata associated with the files in the folder can, additionally, or alternatively, include data indicating a role (e.g., manager, creator, first-time user, top contributor, user having authorization to access, user having authorization to edit, etc.) for each user having access to the folder.

In some implementations, optionally, the file storage application 141 can include a file summarization engine 1412. As shown in FIG. 2A, in some implementations, the file summarization engine 1412 can scan a respective file to extract a file summary 2021 of the respective file from the respective file itself (e.g., when the respective file includes a summary section, a summary sentence, etc.). In some implementations, the file summarization engine 1412 can process the respective file, e.g., using a generative model (193 or another generative model), to generate a respective model output reflecting the file summary 2021 of the respective file. The summary of the respective file can be, for instance, “this document provides a detailed plan for marketing our product A . . . ”

In some implementations, the aforementioned file selection engine 1413 can be configured to select one or more files from the folder as key file(s) to summarize the folder. As a working example, in some implementations, given a folder (or a directory) having a plurality of files, the file selection engine 1413 can select a subset of files from the plurality of files based on one or more selection factors. The one or more selection factors can include, for instance, a first selection factor corresponding to the aforementioned metadata that is associated with the files present within the folder.

The one or more selection factors can include, for instance, a second selection factor corresponding to metadata associated with a user that accesses the folder. The metadata associated with the user that accesses the folder can include, for instance, data indicating a role of the user with respect to a respective file or the folder, e.g., whether the user created the respective file or the folder, whether the user accesses the respective file or the folder for the first time (or less than a predefined number of times, e.g., three times), or whether the user is a visitor invited to browse content stored in the folder or an editor to edit one or more files in the folder. The metadata associated with the user that accesses the folder can, additionally, or alternatively include, for instance, data indicating a relation of the user with respect to other users that have access to the folder. For instance, the metadata associated with a user that accesses the folder can indicate whether the user is a top contributor (e.g., the user who contributed most to the folder) for the folder with respect to other users, and/or indicate whether the user collaborates closely with other users.

Continuing with the working example above, in some implementations, the summary (or original content) of a respective file within the folder can be processed to generate a corresponding content embedding that represents semantic meanings of the respective file. In this case, the one or more selection factors can include, for instance, a third selection factor corresponding to the content embeddings that respectively represent the semantic meanings of the plurality of files within the folder. The file selection engine 1413 can select a subset of files from the plurality of files within the folder based at least on the third selection factor corresponding to the content embeddings that respectively represent the semantic meanings of the plurality of files (or the summaries thereof) within the folder.

In some implementations, the file selection engine 1413 can be in communication with a selection model 191. Optionally, the selection model 191 can be a machine learning (ML) model. Continuing with the working example above, the summaries of the plurality of files from the folder (or the content embeddings thereof), the metadata associated with the plurality of files in the folder, and the metadata associated with the user that accesses the folder can be processed, using the selection model 191, to generate a selection model output indicating the subset of files selected from the folder (e.g., selected from the plurality of files) and/or a selection score determined for each file within the folder. Additionally, or alternatively, the selection model output can indicate an introduction of the subset of files selected from the plurality of files. In some implementations, the introduction of the subset of files, for instance, can include file information (e.g., filename, path, summary, one or more timestamps, etc.) for each file within the subset that is selected from the folder. In this case, the introduction of the subset of files can list the subset of files in an order from a highest selection score to a lowest selection score, where the subset of files each have a selection score that satisfies a selection score threshold.

In some implementations, depending on the metadata processed using the selection model 191 (e.g., metadata associated with the folder or associated with the plurality of files in the folder), the introduction of the subset of files can additionally include the statistics data of the folder (e.g., the total number of files in the folder, a total number for each type of files in the folder, and/or a total number of files in the subset of files selected from the folder). In some implementations, depending on the metadata processed using the selection model 191, the description of the subset of files can, additionally, or alternatively, include the most recent activity associated with the folder (e.g., most recent edit occurred 3 days ago) and/or the first activity associated with the folder (e.g., first file of the folder added 2 years ago). Content of the introduction of the subset of files, however, is not limited herein.

In some implementations, the LLM engine 1419 can be in communication with a generative model 193, and can include, or otherwise access, a prompt-generating engine 149. The prompt-generating engine 149 can generate a prompt based at least on the introduction of the subset of files. For instance, the prompt can at least include the introduction of the subset of files, file content for each file in the subset of files selected from the folder, and/or metadata associated with each file in the subset, etc. Such prompt can be processed as input, using the generative model 193, to generate a generative model output from which a structured summary for the folder is derived.

In some implementations, optionally, the prompt can include the statistics data of the folder (e.g., the total number of files in the folder and/or quantities of different types of files in the folder), the most recent activity associated with the folder (e.g., most recent edit occurred 3 days ago), and/or the oldest activity associated with the folder (e.g., first file of the folder added 2 years ago). In some implementations, optionally, the prompt can further include metadata associated with a user that requests a summary of the folder.

In some implementations, optionally, the prompt can include an instruction to generate a summary (e.g., a structured summary) for the folder. The instruction to generate a summary for the folder can be, for instance, a complex instruction that defines a structure (e.g., sections) of the summary for the folder (also referred to as “folder summary”). For instance, the complex instruction can instruct to generate a first section (e.g., an “overview section”) of the folder summary that provides an overview of the folder. In this case, the summary for the folder derived from the generative model output can include a first section that provides an overview of the folder (e.g., “This folder contains this year's marketing plans for product A. It contains 89 files, mostly documents and slides. It also includes 4 videos, and 4 subfolders.”).

Additionally, or alternatively, the complex instruction can instruct to generate a second section (e.g., a “key topic section”) of the folder summary that includes a list of key topics for the folder (and/or a description for each key topic in the list). In this case, the summary for the folder derived from the generative model output can include a second section that provides a list of key topics for the folder. The second section can include, for instance, a second section title such as “key topics”. The second section can include content such as “target audience, marketing initiatives, goals, evaluations, etc.”, or “target audience—the target audience for product A includes: this year's marketing efforts will focus on logistics, surveying, and manufacturing companies; marketing initiatives— . . . ”

Additionally, or alternatively, the complex instruction can instruct to generate a third section (e.g., a “key file section”) of the folder summary that includes a list of key files from the folder and/or a link to each key file from the list of key files. In this case, the summary for the folder derived from the generative model output can include a third section that provides a list of key/useful files determined for the user. The third section can include, for instance, a third section title such as “key files” or “useful files”. The third section can include content such as a file named “list of companies as target audience”, where the file name of “list of companies as target audience” can be embedded with a link that when executed, causes the file named “list of companies as target audience” to be opened. The third section can further include content, for instance, a short summary of the file(s) listed as the key files.

In some implementations, optionally, the file storage application 141 can further include a file clustering engine 1415, and/or a file & cluster ranking engine 1417. The file clustering engine 1415, and/or the file & cluster ranking engine 1417 can be accessed, for instance, at the server computing device 12 (or the first client computing device 10A, etc.).

In some implementations, optionally, the file clustering engine 1415 can process the subset of files selected from the plurality of files stored in the folder, to divide the subset of files into different groups (e.g., different “file clusters”) each corresponding to a respective topic. In some implementations, the file clustering engine 1415 can divide the subset of files into the different groups based on the content embeddings respectively determined for the files within the subset. For instance, the file clustering engine 1415 can apply a clustering algorithm (e.g., k-means) to divide the subset of files into the different groups based on a similarity value (e.g., distance, cosine similarity, etc.) determined between each pair of content embeddings that are respectively determined for two files within the subset in a latent space of the content embeddings. The file clustering engine 1415 can then divide the subset of files into the different groups based on the similarity values determined for each pair of content embeddings that represent a corresponding pair of files within the subset.

In some implementations, the file clustering engine 1415 can access a clustering model 193. Optionally, the clustering model 193 can be a ML model, such as a generative model. In some implementations, the summary of each file within the subset can be processed, using the clustering model 193, to generate a clustering model output from which a clustering result indicating a division of the subset of files into the different groups can be derived.

In some implementations, optionally, the file & cluster ranking engine 1417 can rank the different groups of files divided from the subset of files selected from the folder. Based on the ranked different group of files, one or more top ranked groups can be determined, and topic(s) corresponding to the one or more top ranked groups can be determined as key topic(s). In some implementations, the file & cluster ranking engine 1417 can determine a key file from the folder for each key topic. In some implementations, the file & cluster ranking engine 1417 can determine key files based on the aforementioned selection scores.

In some implementations, additionally, or alternatively, the prompt processable using the generative model 193 can include the clustering result that indicates the division of the subset of files into the different groups. In some implementations, additionally, or alternatively, the prompt processable using the generative model 193 can include

Optionally, as an example, the aforementioned prompt can include an instruction (e.g., “generate a summary for the folder in the following format: . . . ”) to generate a structured summary for the folder. The prompt can be processed, using a generative model 193, to generate an LLM output from which the structured summary for the folder can be derived. Optionally, depending on the training instances used to train or fine-tune the LLM, the instruction to generate the structured summary for the folder can be omitted.

In some implementations, the structured summary can include, for instance, a first section (e.g., an “overview section”) that provides a short summary that summarizes content and/or other information (e.g., total number of files, file quantity for each type of files, types of files in the folder, etc.) associated with the folder. In some implementations, additionally, or alternatively, the structured summary can include a second section (e.g., a “key topic section”) that lists a plurality of key topics extracted from the content of the folder. In some implementations, the structured summary can include, for instance, a third section (e.g., a “key file section”) that provides a summary for each of a plurality of key files from the folder and/or provides a link to each key file. The key files can be, but do not necessarily need to be, selected from the subset of files based on the key topics.

In various implementations, the generative model 193 may have less than 100 billion parameters, more than 100 billion parameters, or over 200 billion parameters, etc. The greater the number of parameters of a generative model 193, the more complex (or sophisticated) a task (e.g., specified in a user query or request) the generative model 193 can handle. The generative model 193 may be stored at the first client computing device 10A, or at the server computing device 12. For instance, if the memory of the first client computing device 10A restricts the storing of the generative model 193 at the first client computing device 10A or if a length of a textual prompt to be processed using the generative model 193 exceeds a predetermined token length, the generative model 193 may be stored at the server device 12. For instance, if the memory of the first client computing device 10A does not restrict the storing of the generative model 193 at the first client computing device 10A, the generative model 193 may be stored at the first client computing device 10A, to reduce a latency in completing a task (e.g., specified in the user query or request), for instance, by avoiding data communications via the one or more networks 13.

In some implementations, when the generative model 193 is stored at the first client computing device 10A, the maximum token length of content (e.g., text) processable using the generative mode 193 may be a first maximum token length (e.g., <=10,000, <=20,000, <=50,00, <=100,000, etc.). In some implementations, when the generative model 193 is stored at the server device 12, the maximum token length of content (e.g., text) processable using the generative model may be a second maximum token length that is greater than the first maximum token length. The maximum token length can be a maximum number of tokens that is allowed for processing, in a single iteration, using the generative model. In some implementations, the generative model 193 described herein may take various forms, including, but not limited to, model(s) such as Pathways Language Model (PaLM), BERT, Language Model for Dialog Applications (LaMDA), Meena, and/or any other generative model, such as any other generative model that is encoder-only based, decoder-only based, sequence-to-sequence based and that optionally includes an attention mechanism or other memory, diffusion model(s), etc. Generative models may have hundreds of millions, or even hundreds of billions of parameters. In some implementations, generative models may include multi-modal models such as a VLM and/or a VQA model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few. In some implementations, the one or more applications installed at the first client computing device 10A (or 10B) can additionally, or alternatively, include a social media application, a video player, a search application, a note-taking application, a shopping application, a messaging application, and/or any other appropriate applications (or services) installed at, or accessible via, the first client computing device 10A (or 10B).

In various implementations, the server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 10A (or 10B).

In some implementations, the server computing device 12 can further include a training instance generation engine 123. The training instance generation engine 123 can be applied to generate training instances to train (or fine-tune) the aforementioned generative model (e.g., LLM 193), and/or to generate instances to train (or fine-tune) the aforementioned reward model. As described above, the generative model can be trained or fine-tuned, e.g., via supervised learning (or via RLHF using the reward model), to be capable of generating a structured summary for a complex folder.

In various implementations, the one or more applications can further include a virtual assistant 143 that enables human-to-computer dialogues between a user of the virtual assistant and the virtual assistant. In some implementations, the virtual assistant 143 can include a plurality of local or cloud-based components. The plurality of local components (or cloud-based components) can include, for instance, an automatic speech recognition (ASR) engine 1431, a natural language understanding (NLU) engine 1435, a fulfillment engine 1437, and/or a text-to-speech (TTS) engine 1433. In some implementations, the ASR engine 1431, the NLU engine 1435, the fulfillment engine 1437, and/or the TTS engine 1433 may be, but does not necessarily need to be, included in the virtual assistant 143. In some implementations, additionally or alternatively, the plurality of local components at the client computing device 10A (or 10B) can include other component(s) such as the LLM engine 1419.

In some implementations, the ASR engine 1431 (and/or a cloud-based ASR engine) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10A, remote ML models that are executed remotely from the server computing device (e.g., at remote server device 12), or shared ML models that are accessible to both the client computing device 10A and/or remote systems (e.g., the remote server computing device 12). The audio data can be acquired from audio recordings or can be generated by microphone(s) of the client computing device 10A (or 10B). Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 1431 can select one or more of the ASR hypotheses as corresponding recognized text (“transcript”) that corresponds to the spoken utterance(s) (e.g., selected based on the corresponding predicted measures).

In some implementations, the NLU engine 1435 can determine semantic meaning(s) of audio and/or text converted by the ASR engine from audio, and decompose the determined semantic meaning(s) to determine intent(s) and/or parameter(s) for an assistant action. For example, the NLU engine 1435 can determine an intent and/or parameters for an assistant action based on the aforementioned recognition of the spoken utterance generated by the ASR engine 1431.

In some implementations, the NLU engine 1435 can resolve the intent(s) and/or parameter(s) based on a single utterance of a user. In this case, the fulfillment engine 1437 can receive the intent and/or parameter(s) of the intent to fulfill the intent by performing a corresponding assistant action via the virtual assistant 143. For example, given a single utterance of “what's the weather today in Louisville?”, the fulfillment engine 1437 can fulfill the intent (e.g., a search intent) by: (1) causing a search engine to search the Internet using a search parameter of “weather today in Louisville” for an answer/response to the user query of “what's the weather today in Louisville?”, (2) generating fulfillment information (e.g., “it's cloudy outside, with a temperature of 26° C.”), based on a search result (e.g., “Louisville, KY, Monday 11:00 am, cloudy, 26° C.”) of the search, and/or (3) rendering the fulfillment information to the user of the client computing device 10A (or 10B) as the answer (or response).

As another example, given a single utterance of “set the thermostat to 72 F”, the fulfillment engine 1437 can receive an intent (e.g., control<device>) and/or parameter(s) (e.g., device name of “thermostat”, temperature of “72 F”) for an assistant action that causes a thermostat to set room temperature at 72 F. In this example, the fulfillment engine 1437 can fulfill the intent by generating and forwarding a control signal to the thermostat, where the control signal causes the thermostat to set the room temperature at 72 F.

FIG. 2A illustrates an example scenario where a structured summary is generated for a folder using techniques described in accordance with various implementations of the present disclosure. FIG. 2B illustrates a user interface of a file storage application showing a folder, in accordance with various implementations of the present disclosure. FIG. 2C illustrates a user interface of a file storage application showing a summary generated for the folder in FIG. 2B, in accordance with various implementations of the present disclosure.

As shown in FIG. 2A, a user may provide a user request 201 to summarize a folder to a client computing device 20 (see in FIG. 2B, e.g., a laptop). The user request 201, for instance, can be received via a spoken utterance (or a typed input) of a user, where the spoken utterance (or the typed input) can be, for instance, “Summarize this folder”. As another example, the user request 201 to summarize a folder can be received via a user click of a selectable graphical user interface (GUI) element displayed at a user interface (e.g., 200 in FIG. 2B) of a file storage application (e.g., “file storage app” in FIG. 2B). The way the user request 201 is received, however, is not limited to descriptions herein, which can also be via a touch input, etc. The content of the user request 201 is also not limited to descriptions herein, and in some implementations, the user request 201 may not need to be received when the user is accessing the folder in situations where the user request 201 specifies a name or ID of the folder. For instance, the user request 201 can be, a user utterance of “summarize my shared folder for Project Avocado”.

In some implementations, in response to receiving the user request 201, the file fetching engine 1411 can fetch files (e.g., all files) within the folder. The files fetched within the folder, for instance, can include files stored with sub-folder(s) of the folder, if there is any subfolder within the folder. In some implementations, the file fetching engine 1411 can fetch metadata associated with the folder, metadata associated with one or more files (e.g., all folders) within the folder, and/or metadata associated with the user. The metadata associated with the one or more files within the folder can be, but does not necessarily need to be, part of the metadata associated with the folder.

Referring to FIG. 2A, as a non-limiting example, the file fetching engine 1411 can fetch “content of files” 202 stored within the folder, “metadata of files” 203 stored within the folder, metadata associated with the user (also referred to as “user metadata”, see reference number 204), and metadata associated with the folder (e.g., statistics data 205).

In some implementations, the fetched “content of files” 202 (associated with the folder) can include, for instance, content for each file within the folder. As a non-limiting example, the content for each file within the folder can include content for a first file within the folder. The content for the first file within the folder can include natural language content such as, “This lease Agreement is entered into this [date] by and between . . . ”. The metadata of files 203 (that are stored within the folder) can include metadata of the first file, including, for instance, a file name (e.g., “Lease Agreement. pdf”) of the first file, a title (e.g., “Lease Agreement”) of the first file, a path or location (e.g., “Client files: Client A>Client files>Contracts”) of the first file, user activities of the first file, and/or a file ID (e.g., File_0) of the first file. The user activities of the first file, for instance, can at least include a most recent user activitiy (e.g., “modified_5 weeks ago” or “modified by user A_5 days ago”). The user activities of the first file can, additionally or alternatively, include an oldest user activity (e.g., “created_two month ago”, “shared with user B_6 weeks ago”, etc.). The present disclosure is not intended to be limiting. For example, the user activities of the first file can, additionally, or alternatively, include a user action such as “Sam asked you to review the lease agreement”, “Ella asked to be an editor of the lease agreement”, or “Martin commented saying the agreement looks good to him”, etc.

In some implementations, the metadata 204 associated with the user can include, for instance, a role of the user with respect to the folder (or one or more files thereof). The role of the user with respect to the folder (or a particular file in the folder) can be, for instance, a creator of the folder (or the particular file), a user authorized to edit the folder (or the particular file), a user authorized to read and only read the folder (or the particular file), a top contributor of the folder (or the particular file), a co-manager of the folder (or the particular file), a list of user IDs for users having access to the folder (or the particular file), a frequency of interactions between the user and one or more other users having access to the folder.

In some implementations, the statistics data 205 associated with the folder can include a total number (e.g., “88”) of files in the folder, and/or a total number of each type of files within the folder. The statistics data 205 can indicate, for instance, there is a total number of 60 document type of files (i.e., “documents”) within the folder, a total number of 22 spreadsheet type of files (“spreadsheet”) within the folder, and a total number of 2 image type of files (i.e., “images”) of an image type of files within the folder.

In some implementations, the information fetched by the file fetching engine 1411 in response to the user request 201, or a portion thereof, can be processed using the file section engine 1413, to select a subset of files (“207”) from all files within the folder. For instance, a first subset of files (e.g., new files or updated files since last visit of the user) can be selected from the folder if the user metadata 204 indicates that the user is familiar with the folder, and a second subset of files (e.g., a majority of files within the folder) can be selected from the folder if the user metadata 204 indicates that the user is unfamiliar with the folder (e.g., being a first-time visitor of the folder).

In some implementations, all the files within the folder (or a portion thereof, e.g., the subset of files selected from all the files) can be processed using the file summarization engine 1412. For instance, file content of a respective file within the folder (or within the selected subset from the folder) can be processed, to generate a summary of the respective file. Optionally, the summary of the respective file can be extracted directly from the respective file (e.g., in case the respective file includes a summary sentence or a summary section). Optionally, the summary of the respective file can be generated based on processing the file content of the respective file, using a generative model (e.g., a generative model 193). For instance, a file summary request (not illustrated) can be generated to include the file content of the respective file and an instruction that instructs to generate a file summary for the respective file. The file summary request (in natural language) can be processed as input, using the generative model, to generate a model output reflecting the file summary of the respective file.

In some implementations, the file summary of the respective file can be processed (e.g., using an encoder model 1421) to generate a respective content embedding for the respective file that represents the file summary of the respective file. Alternatively, instead of the file summary, the file content (e.g., in its entirety) of the respective file can be processed to generate the respective content embedding for the respective file. In this case, the respective content embedding represents the file content of the respective file. The text encoder can be, for instance, a machine learning model trained or fine-tuned to generate a content embedding (in the format of numerical vectors) for text content.

In some implementations, the content embeddings 2021 generated for all files within the folder (or the selected subset thereof) can be processed, e.g., using the file clustering engine 1415, to generate a clustering result 206. The clustering result 206 can indicate, for instance, that the files within the folder (or the selected subset of files within the folder) can be divided into a plurality of groups, where each pair of files within the same group can have a corresponding pair of content embeddings (in the format of numerical vectors) showing a distance (e.g., in the numerical vector space) less than a distance threshold (or a similarity satisfying a similarity threshold). The clustering result 206, for instance, can be acquired via K-means.

In some implementations, the clustering result 206 can further indicate, for each group of files divided from the folder (or the selected subset), a ranking score. In some implementations, the file & cluster ranking engine 1417 can select one or more top-ranked clusters/groups 2061 (e.g., based on the ranking scores (of the groups of files divided from the folder (or from the selected subset). The ranking score for each group can be determined, for instance, based on a silhouette score that measures a clustering quality for a respective group divided/clustered from the selected files (e.g., 207, or in other cases, from all files of the folder).

In some implementations, file content of the top-ranked groups 2061, the statistics data 205 for the folder, user metadata 204, and/or metadata of files within the top-ranked groups 2061 can be transmitted to the prompt-generating engine 149, to generate a prompt 208B (may also be referred to as “folder summary request”). In some implementations, the top-ranked groups 2061 can be transmitted to the file selection engine 1413 (instead of the prompt-generating engine 149), to generate the subset of files 207, where the subset of files 207 is transmitted to the prompt-generating engine 149, to generate the prompt 208B. In some implementations, for each of the top-ranked groups 2061, one or more key files can be selected (e.g., based on the clustering result, etc.). In this case, the one or more key files selected for a respective top-ranked group (belonging to the top-ranked groups 2061) can be transmitted to the file selection engine 1413 to generate the subset of files 207, or can be transmitted to the prompt-generating engine 149 to generate the prompt 208B. The present disclosure is not intended to be limiting.

The prompt 208B can include, for instance, a complex instruction 208A (including one or more instructions), in addition to the aforementioned file content of the top-ranked groups 2061, the statistics data 205 for the folder, user metadata 204, and/or metadata of files within the top-ranked groups 2061.

The prompt 208B can be processed as input, by the LLM engine 1419 and using the generative model 193, to generate a model output reflecting a folder summary 209A. For instance, the model output can indicate a plurality of folder summary candidates and/or a confidence score for each folder summary candidate from the plurality of folder summary candidates. In this case, the folder summary 209A can be a top ranked folder summary candidate that has the highest confidence score.

As a non-limiting example, the prompt 208B can include the statistics data 205 for the folder, followed by certain metadata associated with the folder, each of the aforementioned top-ranked groups of files, and the complex instruction 208A. The top-ranked groups of files can each correspond to a key topic, and can be presented in a format that identifies metadata for each file (e.g., “filename”, “title”, “location”, “last edit”) as well as file content of each file. The instruction 208A can be, for instance, “Above is a selection of files from a folder arranged into different groups. For each group, select one or more files (e.g., 3) to determine a key topic for a respective group. Given this, please summarize the folder in the following structured format:

```
{{
  ″overview″: ″A one/two paragraph summary of the folder, including
overview, audience, file counts and types, and dates of recent activity. ″
  ″key_topics″: [
    {{
      ″topic_title″: ″<title>″, // Short title of the topic
      ″topic_summary″: ″<summary>″, // Summary of a key topic
discussed above, citing files when appropriate. This can be verbose and
cite specific, useful details where appropriate.
      // Files relevant to this topic
      ″files″: [
          {{
            ″id″: ″FILE<n>″,
            ″title″: ″<title>″,
            ″summary″: <summary>″, // A brief description of the file,
surfacing specific useful details when relevant.
        ]
    }}
  ]
              }}”
```

As another example, the instruction 208A can be, for instance, “Above is a selection of files from a folder arranged into different groups. For each group, select one or more files (e.g., 3) to determine a key topic for a respective group. For a newcomer, select the files most useful to reflect the topic, and for a user familiar with the folder, select the most recent files for the topic. Given this, please summarize the folder in the following structured format:

```
{{
  ″overview″: ″A one/two paragraph summary of the folder, including
overview, audience, file counts and types, and dates of recent activity. ″
  ″key_topics″: [
    {{
      ″topic_title″: ″<title>″, // Short title of the topic
      ″topic_summary″: ″<summary>″, // Summary of a key topic
discussed above, citing files when appropriate. This can be verbose and
cite specific, useful details where appropriate.
      // Files relevant to this topic
      ″files″: [
        {{
          ″id″: ″FILE<n>″,
          ″title″: ″<title>″,
          ″summary″: <summary>″, // A brief description of the file,
surfacing specific useful details when relevant.
        ]
    }}
  ]
            }}”
```

In some implementations, optionally, one or more groups from the clustering result 206 that are still relatively highly ranked and that are not selected to form the subset of files 207 can be utilized to determine one or more suggested topics 209B. For instance, the top-ranked groups 2061 can include a first group having the highest ranking score, and a second group having the second highest ranking score. In this case, a third group of files having the third highest ranking score, while not selected as part of the subset 207 of files to generate the folder summary 209A, can be processed to generate a suggested topic 209B, the suggested topic 209B can be rendered by the rendering engine 102 (e.g., as a selectable element leading to the third group of files or a representative file thereof) with respect to the folder summary 209A. In some implementations, a response 209 responsive to the user input 201 can include the folder summary 209A. In some implementations, the response 209 can further include the suggested topic(s) 209B, and/or other data (e.g., a disclaimer).

Referring to FIG. 2B, as a non-limiting example, a user may be accessing a file storage app using a client device 20. The user may be accessing a folder named “Intelligence” that is shared with the user (e.g., by a co-worker of the user). The folder “Intelligence” may be shared with 10 groups of users, where a total number of the users can be 42. This can result in the folder “Intelligence” being a large folder having numerous files and several sub-folders. For instance, as shown in FIG. 2B, the folder “Intelligence” can include a first sub-folder named “MEETING”, a second sub-folder named “UI DESIGN”, a third sub-folder named “MODEL”, a document named “HOMEPAGE”, and a message, etc. Without techniques described herein, given a complex folder like the folder “Intelligence”, the user may feel lost and try to click each sub-folder one-by-one, and scanned files such as the document “HOMEPAGE” and a vast of files within each sub-folder (“MEETING”, “UI DESIGN”, “MODEL”). This can be extremely time-consuming and resource-consuming, which takes a lot of computational resources and network resources as different tools/services may be utilized to provide access to the different types of files in the folder (and/or sub-folders).

By leveraging a generative model (e.g., 193 in FIG. 2B) in generating a summary of the folder that summarizes key content/files in the folder as described in various implementations of this disclosure, a user, however, can have a comprehensive understanding of the folder, without opening a majority of files within the folder that can consume an intensive amount of computational resources and extended period of time to review those files. For example, referring to FIG. 2B, the user can click the selectable element 220, to trigger the generation of a folder summary. In response to receiving the user click of the selectable element 220 that triggers the generation of a folder summary, the system can determine that the user is currently accessing the folder “Intelligence”, and thus generate a folder summary for the folder “Intelligence”. The generation of such folder summary can be performed, for instance, using components and/or processes as illustrated in FIG. 2B.

As shown in FIG. 2C, a folder summary 222 can pop up in response to the user clicking the selectable element 220. The folder summary 222 can include, for instance, the following content:

“1. Overview
The folder ’Intelligence” contains 229 documents, spreadsheets, slides,
drawings, and emails related to a project of developing app A, with files
modified as recently as 3 days ago.
2. Key topics
A. APP UIs: design UI for the homepage
B. model: machine learning model trained using a manually curated
training set
C. Schedule: APP to be released Q3 this year
3. Useful Files
File 1: outlines the design for the homepage and UIs subsequently
File 2: Experimental log for training the ML model”

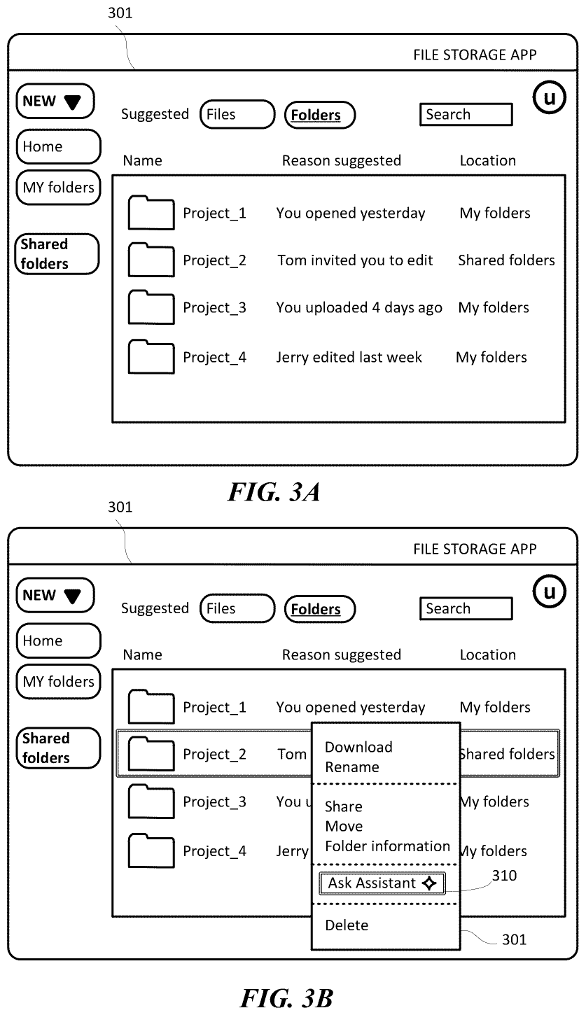

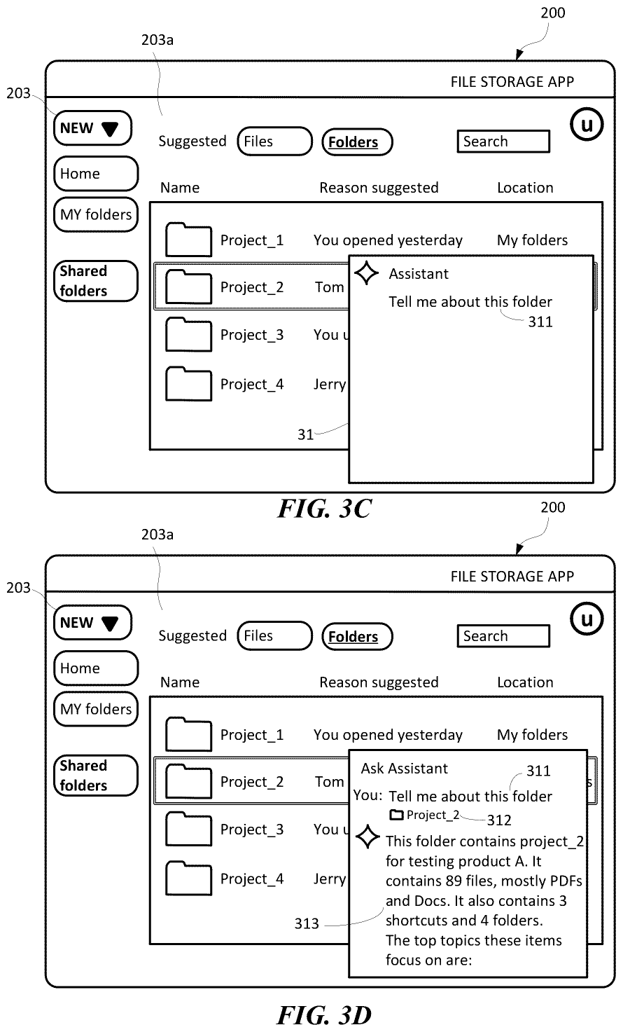

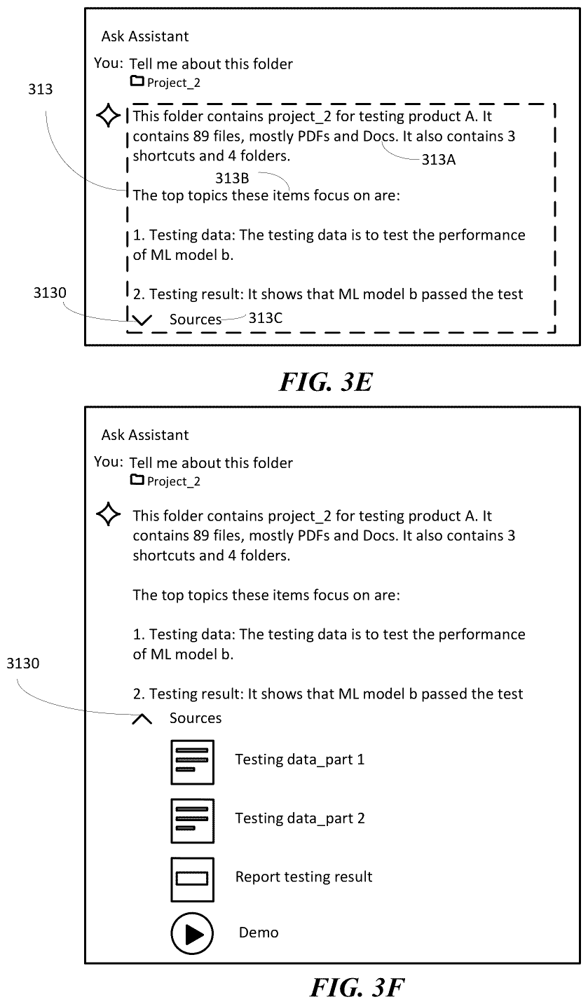

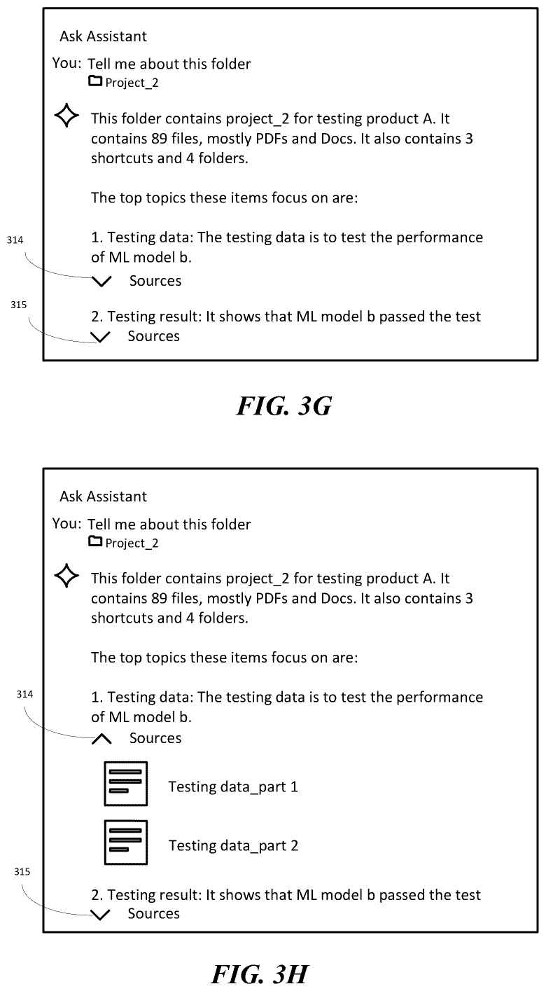

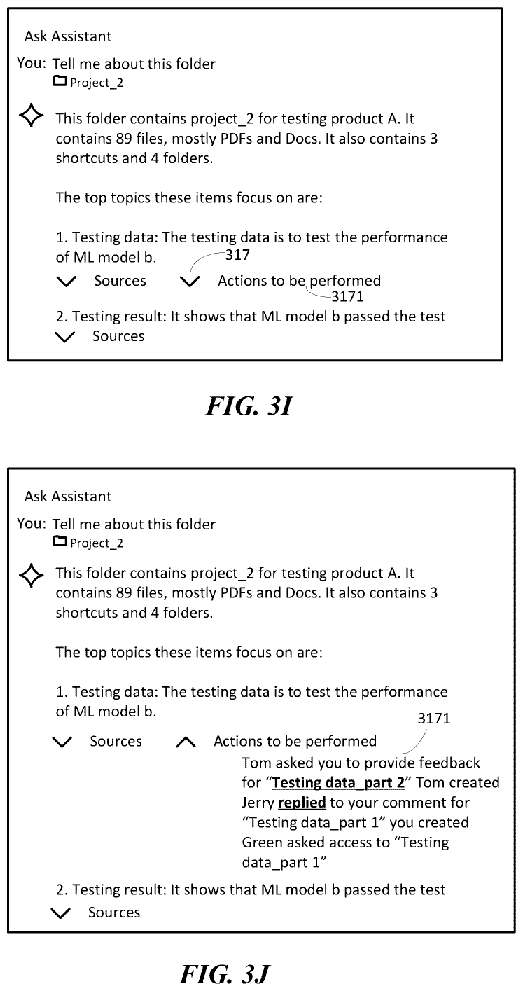

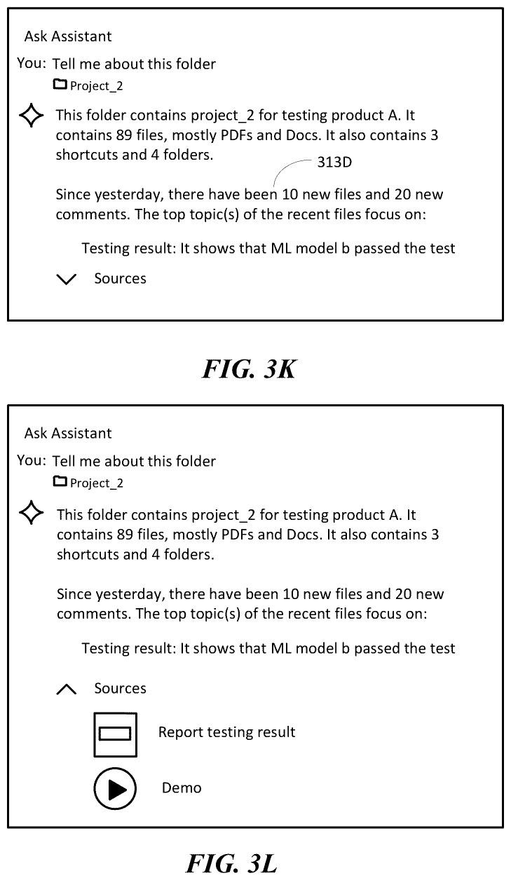

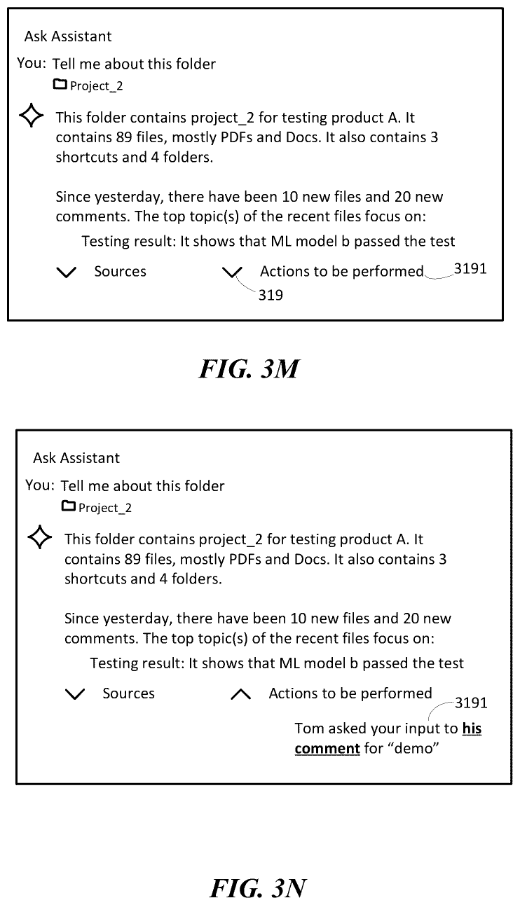

FIG. 3A illustrates another example user interface of a file storage application showing a folder, in accordance with various implementations of the present disclosure. FIG. 3B illustrates a user interface showing the usage of a virtual assistant in generating a folder summary for the folder in FIG. 3A, in accordance with various implementations of the present disclosure. FIG. 3C illustrates an example user request for a folder summary for the folder in FIG. 3A/3B, in accordance with various implementations of the present disclosure. FIG. 3D illustrates an example pop-up window showing a portion of a folder summary generated in response to the user request in FIG. 3C, in accordance with various implementations of the present disclosure.

As shown in FIG. 3A, a user (“U”) may be accessing a homepage 301 of a file storage app, where the homepage 301 lists one or more folders suggested for the user to access. Optionally, the one or more folders can include, for instance, a first folder named “Project_1”, a second folder named “Project_2”, a third folder named “Project_3”, and/or a fourth folder named “Project_4”. Optionally, the first folder named “Project_1” can be recommended by a recommendation system based on the user opening the first folder recently (e.g., “yesterday”). Optionally, the second folder named “Project_2” can be recommended by the recommendation system based on the user being invited (e.g., by “Tom”) to edit the second folder. Optionally, the third folder named “Project_3” can be recommended by the recommendation system based on the third folder being uploaded by the user recently (e.g., 4 days ago). Optionally, the fourth folder named “Project_4” can be recommended by the recommendation system based on it was recently edited (e.g., by another user “Jerry” last week).

In some implementations, the user can select the second folder “Project_2” (e.g., by right-click) and select to activate a virtual assistant (e.g., by selecting the option 310 “Ask Assistant” via a pop-up menu window 301). In some implementations, in response to the user selecting the option 310 that activates the virtual assistant, a user interface 31 of the virtual assistant can be rendered (e.g., visually as an overlay with respect to a user interface 300 of the file storage app). The user interface 31 can be rendered to receive typed user input(s), to display a transcript of spoken user input(s), to show assistant input (e.g., responses, suggestions, etc.), etc.

As shown in FIG. 3C, a user may provide an utterance of “Tell me about this folder”, and a speech recognition 311 (“Tell me about this folder” in natural language) of the utterance can be displayed within the user interface 31 of the virtual assistant. In some implementations, the virtual assistant can determine that the utterance of “Tell me about this folder” is directed to the second folder “Project_2”, e.g., based on the virtual assistant being triggered in association with the second folder “Project_2”. Optionally, as shown in FIG. 3D, a filename 312 (or file ID, etc.) of the second folder “Project_2” can be displayed with respect to the speech recognition 311 (“Tell me about this folder” in natural language) of the utterance. This way, the user can be ensured that the virtual assistant correctly determines the folder the user is interested in. The filename 312, for instance, can be embedded with a link to the second folder “Project_2”, but this is not required.

In some implementations, optionally, the filename 312 (or file ID, etc.) of the second folder “Project_2” can be displayed in response to receiving the utterance from the user. In some implementations, optionally, partial content from a folder summary (e.g., 313 in FIG. 3E) generated for the second folder “Project_2” can be displayed in response to receiving the utterance from the user.

FIG. 3E illustrates an example folder summary generated in response to the user request in FIG. 3C, with full content illustrated, in accordance with various implementations of the present disclosure. FIG. 3F illustrates a folder summary showing unfolded source information with respect to FIG. 3E, in accordance with various implementations of the present disclosure.

As shown in FIG. 3E, the folder summary 313 generated using techniques described in this disclosure can include one or more portions (313A, 313B, and/or 313C, etc.). For instance, the folder summary 313 can include a first folder summary portion 313A that provides an overview of files within the selected folder “Project_2”. The overview of the files within the selected folder “Project_2” can be, for instance, “This folder . . . ”.

Additionally, or alternatively, the folder summary 313 can include a second folder summary portion 313B that provides one or more key topics generated for the selected folder “Project_2”. The one or more key topics can, for instance, be supplemented with a corresponding key topic description (e.g., one-sentence description for each key topic). The one or more key topics can include, for instance, a first key topic of “Testing data” and a second key topic of “Testing result”. As a non-limiting example in FIG. 3E, a key topic description for the first key topic of “Testing data” can be, for instance, “The testing data is to test the performance of ML model b”. A key topic description for the second key topic of “Testing data” can be, for instance, “It shows the ML model b passed the test”.

Additionally, or alternatively, the folder summary 313 can include a third folder summary portion 313C (“Sources”) that provides one or more key files for the folder. As shown in FIG. 3E, the one or more key files can be hidden under a section title of “Sources”, where the one or more key files can be unfolded and visually rendered in response to the user selecting a selectable GUI element 3130. For instance, referring to FIG. 3F, key files such as a first key file (e.g., document) named “Testing data_part 1”, a second key file (e.g., document) named “Testing data_part 2”, a third key file (e.g., slides) named “Reporting testing result”, and/or a fourth key file (e.g., video) named “Demo” can be rendered as part of the folder summary 313 for the selected folder “Project_2” in response to receiving user selection of the selectable GUI element 3130.

Alternatively, FIG. 3G illustrates another example folder summary generated in response to the user request in FIG. 3C, with full content illustrated, in accordance with various implementations of the present disclosure. FIG. 3H illustrates a folder summary showing unfolded source information with respect to FIG. 3G, in accordance with various implementations of the present disclosure. As shown in FIGS. 3G and 3H, the aforementioned key files can be rendered visually in association with the key topics (e.g., in response to receiving a user selection of a selectable GUI element 314. For example, as shown in FIG. 3H, the first key file named “Testing data_part 1” and the second key file named “Testing data_part 2” can be rendered in association with the first key topic of “Testing data”. Optionally, such first and second key files may be files selected to determine the first key topic (i.e., “Testing data), as the instruction 208A instructs. While not illustrated in FIG. 3H, in response to the user selecting a selectable GUI element 315, the third key file named “Reporting testing result”, and/or a fourth key file named “Demo” can be rendered.

Alternatively, FIG. 3I illustrates a further example folder summary generated in response to the user request in FIG. 3C, with full content illustrated, in accordance with various implementations of the present disclosure. FIG. 3J illustrates a folder summary showing unfolded action information with respect to FIG. 3I, in accordance with various implementations of the present disclosure. As shown in FIG. 3I, the aforementioned key topics can be rendered visually in association with one or more actions (“Actions to be performed”). In response to receiving a user selection of a selectable GUI element 317, the one or more actions 3171 (see details in FIG. 3J) with respect to the key topic of “Testing data” can be rendered. The one or more actions can include, for instance, a first action of editing based on metadata for key files of the key topic “Testing data” including a message or comment of “Tom asked you to provide feedback for ‘Testing data_part 2’ Tom created”. Additionally or alternatively, the one or more actions can include a second action suggesting a review of a comment or reply, such as “Jerry replied to your comment for ‘Testing data_part 1’ you created”. Additionally or alternatively, the one or more actions can include a third action with respect to file or folder access, such as “Green asked access to ‘Testing data_part 1’”.

Alternatively, FIG. 3K illustrates an additional example folder summary generated in response to the user request in FIG. 3C, with full content illustrated, in accordance with various implementations of the present disclosure. FIG. 3L illustrates a folder summary showing unfolded source information with respect to FIG. 3K, in accordance with various implementations of the present disclosure. As shown in FIG. 3K, the folder summary 313 can, additionally, or alternatively, include a fourth folder summary portion 313D corresponding to recent update(s) to the selected folder of “Project_2”. The recent update to the selected folder of “Project_2” can include, for instance, content summarizing recent update to the selected folder of “Project_2”, such as “Since yesterday, there have been 10 new files and 20 new comments” or “Since yesterday, there have been 10 new files and 20 new comments to the sub-folder of ‘Testing result’”. In some implementations, the fourth folder summary portion 313D corresponding to recent update to the selected folder (e.g., “Project_2”) can be rendered in response to the aforementioned user metadata indicating the user is familiar with the selected folder (e.g., “Project_2”). For instance, the system can determine that the user is familiar with the selected folder based on the user activities of the selected folder shows frequent visits of the user to the selected folder, or frequent edits/comments provided by the user for file(s) within the selected folder, etc.

In some implementations, optionally, in cases where the folder summary includes the fourth folder summary portion 313D corresponding to recent update to the selected folder, the key topics in the second folder summary portion 313B can be generated based on files reflecting the recent update (which can be further selected from the aforementioned subset of files based on temporal conditions, e.g., since yesterday, etc.). For instance, as shown in FIG. 3K, the key topics reflecting recent updates can include the second key topic of “Testing result” and not include the first key topic of “Testing data”, based on recent updates are mostly directed to files clustered in association with the second key topic of “Testing result”. In this case, the user can access key files associated with the second key topic of “Testing result”, such as the presentation of “Report testing result” and the demo (see FIG. 3L).

Alternatively, FIG. 3M illustrates an even further example folder summary generated in response to the user request in FIG. 3C, with full content illustrated, in accordance with various implementations of the present disclosure. FIG. 3N illustrates a folder summary showing unfolded action information with respect to FIG. 3K, in accordance with various implementations of the present disclosure. As shown in FIG. 3M, the key topic of “Testing result” can be rendered visually in association with one or more actions (“Actions to be performed”). In response to receiving a user selection of a selectable GUI element 319, the one or more actions 3191 with respect to the key topic of “Testing result” can be rendered. As shown in FIG. 3N, the one or more actions with respect to the key topic of “Testing result” can include, for instance, an invite to edit a key file associated with the key topic of “Testing result”, such as “Tom asked your input to his comment for ‘demo’”. In some implementations, links can be provided to facilitate the user access to the key file (e.g., “demo”).

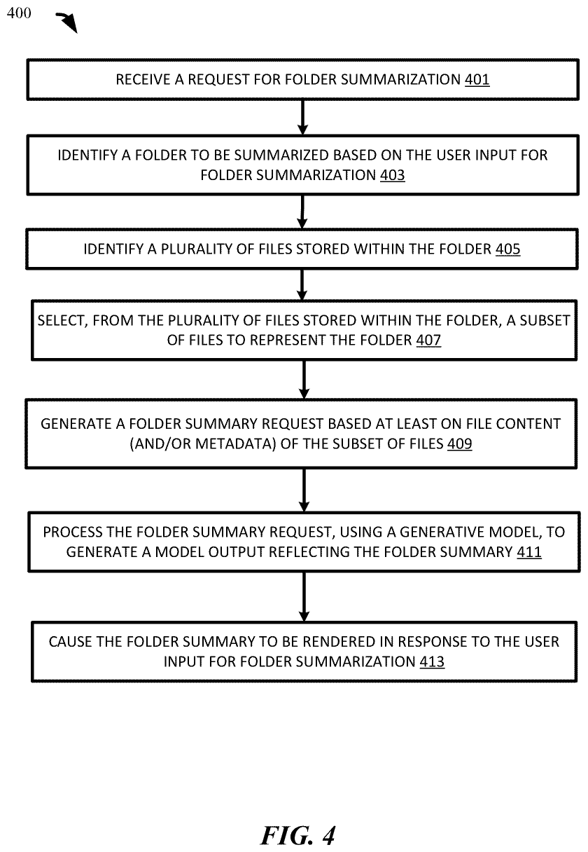

Turning now to FIG. 4, a flowchart illustrating a method for summarizing a folder, in accordance with various aspects of the present disclosure. A system for performing the method 400 includes one or more processors, memory, and/or other component(s) of computing device(s) (e.g., the first client computing device 10A of FIG. 1, one or more servers such as the server computing device 12, and/or other computing devices). Moreover, while operations of the method 400 are shown in a particular order, this is not meant to be limiting. One or more operations may be reordered, omitted, and/or added.

In various implementations, at block 401, the system receives, at a client device, a request (e.g., a user input) for folder summarization. The client device can be a laptop, a cell phone, or any other applicable computing device having one or more input devices (e.g., keyboard, touch screen, microphone, etc.) to receive the user input.

In some of the various implementations, the user input for folder summarization can explicitly identify a folder to be summarized. For example, the user input can be a spoken utterance (a typed input, etc.) of “Summarize the folder named ‘Trip to San Francisco’”. In some of the various implementations, the user input for folder summarization may not explicitly identify the folder to be summarized. For example, the user input can be a spoken utterance (a typed input, etc.) of “Summarize this folder”.

In some of the various implementations, the system can receive the user input for folder summarization via an audible user interface (or a graphical user interface) of a virtual assistant application (“virtual assistant”) that is in communication with a folder storage application (or a folder storage system) as described above. In some of the various implementations, the system can receive the user input for folder summarization via an input field of the folder storage application or system, or via an audible user interface of the folder storage application or system. The present disclosure, however, is not limited thereto.

In various implementations, at block 403, the system identifies a folder to be summarized based on the user input for folder summarization.

In some of the various implementations, the system can identify the folder to be summarized based on an identifier (e.g., file ID, file name, etc.) of the folder recognized from content of the user input. In some of the various implementations, the system can determine the folder to be summarized based on metadata associated with the user input for folder summarization. For instance, the system can determine the folder to be summarized based on identifying content of a user interface of a client device showing a current folder a user of the user input is accessing (or a folder the user selects), and determining the current folder (or the selected folder) as the folder to be summarized.

In various implementations, at block 405, the system identifies/fetches a plurality of files stored within the folder.

In some of the various implementations, the folder, for instance, can be a personal folder personal to the user. In some of the various implementations, the folder can be a shared folder shared with a plurality of users that include the user of the user input. In some implementations, the folder can be a dynamic folder updated or edited by the user (or one or more of the plurality of users). For instance, the folder can be updated by two or more users at approximately the same time, or by the user (or different users) at different times.

In some of the various implementations, the folder can include a plurality of files, and/or one or more subfolders. Each subfolder can include one or more files and/or one or more additional subfolders. The plurality of files in the folder can be of the same type, and can be of different types. For instance, the plurality of files can include, but are not limited to, documents, emails, images, spreadsheets, slides, etc.

In some of the various implementations, the folder can be stored at the folder storage application, or any applicable application (or service) that stores folders and/or files. In some of the various implementations, the folder can be stored locally at the client device. In some of the various implementations, the folder can be stored remotely at a server device, or can be stored via a cloud service.

In some implementations, identifying the plurality of files stored within the folder includes: identifying all files stored within the folder, including all files stored within sub-folder(s) of the folder, if there is any sub-folder.

In various implementations, at block 407, the system selects, from the plurality of files stored within the folder, a subset of files to represent the folder. In some of the various implementations, the subset of files can be divided into one or more groups of files. For instance the subset of files can include a first group of files corresponding to a first key topic and a second group of files corresponding to a second key topic. In some implementations, content of the first key topic and/or content of the second key topic is not determined at block 407. For instance, the content of the first key topic (or the content of the second key topic) can be determined based on a model output of a generative model acquired based on processing the first group of files (or the second group of files) at block 409 as described below.

In some of the various implementations, optionally, the system can select, from the plurality of files stored within the folder, the subset of files to represent the folder by: selecting files from the plurality of files stored within the folder (e.g., by filtering out one or more files); generating a content embedding for each selected file, where the content embedding of a respectively selected file numerically represents content of the respectively selected file; grouping (“clustering”), based on the content embedding for each selected file, the selected files into a plurality of file groups (e.g., the aforementioned “clustering result”), wherein each file group includes one or more files having a similarity satisfying a similarity threshold; ranking the plurality of file groups; and selecting one or more top ranked file groups to form the subset of the files representing the folder. Optionally, the system can select the one or more top ranked file groups based on a silhouette score that measures a clustering quality for each file group divided/clustered from the selected files (or in other cases, from all files of the folder). In some of the various implementations, the system can select files from the plurality of files stored within the folder, for instance, based on scanning each file within the folder to filter out one or more files (e.g., a duplicated file).

In some implementations, the content embedding for a file can be a word embedding (in the format of numerical vector(s)) converted from textual content. In some implementations, the content embedding for a file can be an image embedding (in the format of numerical vector(s)) converted from pixels of visual content (e.g., image, video, etc.).

In some implementations, optionally, the step of selecting files from the plurality of files stored within the folder can be omitted. In this case, the system can select, from the plurality of files stored within the folder, the subset of files to represent the folder by: generating a content embedding for each file from the folder, the content embedding of a respective file numerically represents content of the respective file from the folder; grouping, based on the content embedding for each file from the folder, the plurality of files from the folder into a plurality of file groups; ranking the plurality of file groups; and selecting one or more top ranked file groups to form the subset of the files representing the folder. Optionally, each file group can include one or more files having an evaluation score (e.g., silhouette score) satisfying a score threshold.

In some of the various implementations, the content embedding of the respective file (e.g., text file) is generated based on processing file content (e.g., in its full length) of the respective file using a text encoder. In some of the various implementations, the content embedding of the respective file (e.g., an image) is generated based on processing file content (e.g., image pixels) of the respective file using an image encoder.

In some of the various implementations, the content embedding of the respective file (e.g., text file) is generated based on processing a file summary of the respective file using a text encoder. In some of the various implementations, the file summary of the respective file is extracted from the respective file. In some of the various implementations, the file summary of the respective file is generated based on processing file content of the respective file using the generative model or an additional generative model.

In some implementations, in case the respective file is an image, the content embedding of the respective file (e.g., the image) can be generated based on processing image pixels of the image. Additionally, or alternatively, the content embedding of the respective file (e.g., the image file) can be generated based on processing text description(s) determined for the image. The text descriptions for the image can include, for instance, a caption of the image generated using an image-captioning model, a VLM, a VQA, etc. The text descriptions for the image can additionally, or alternatively, include, for instance, one or more characters present in the image and recognized from the image using an optical character recognition (OCR) model.

In some of the various implementations, the system can select files from the plurality of files stored within the folder, for instance, based on one or more selection factors as described previously, with or without generating the aforementioned content embeddings. Such selected files can form the subset of files to be processed at block 409.

In various implementations, at block 409, the system generates a folder summary request based at least on file content (and/or metadata) of the subset of files. The folder summary request can be in natural language and includes the subset of files (and/or metadata associated therewith). The folder summary request can further include an instruction (e.g., a complex instruction) that instructs to generate a plurality of portions (e.g., a first portion and a second portion) forming the folder summary for the folder. For instance, the first portion of the folder summary for the folder can be an “overview” portion that provides an overview of the folder. The second portion can be, for instance, a “key topic” portion that provides one or more key topics determined from the subset of files.

In some of the implementations, as a working example, the folder can be a folder named “Lunar project”, and the folder summary request for the folder “Lunar project” can include the subset of files formatted as follows:

```
“files”: [
  {
    “filename”: “rocket_specs.pdf”,
    “title”: “Rocket Specs”,
    “path”: “Mission Documents > Design Specifications > Rocketry”,
    “content”: “This document details the specifications....”,
    “modified”: “2 weeks ago”,
    “file_id”: “FILE_0”
  },
  {
    “filename”: “lunar_module_design.docx”,
    “title”: “Lunar Module Design”,
    “path”: “Mission Documents > Design Specifications > Lunar
    Module”,
    “content”: “Lunar Module Design | The Lunar Module...”,
    “modified”: “5 weeks ago”,
    “file_id”: “FILE_1”
  },
  {
    “filename”: “landing_schedule.xlsx”,
    “title”: “Lunar Landing Schedule”,
    “path”: “Mission Objectives > Lunar Landing”,
    “content”: “Lunar Landing Schedule | A detailed timeline...”,
    “modified”: “2 weeks ago”,
    “file_id”: “FILE_2”
  },
  ]
```

Continuing with the working example above, in some of the implementations, the folder summary request can include a complex instruction formatted as follows:

```
“Above is a selection of files from a folder. I would like you to create a
summary of this folder. Please summarize the folder in the following
format:
  ″topic_title″: ″<title>″, // Short title of the topic
    ″topic_summary″: ″<summary>″
    // Files relevant to this topic
    ″files″: [
      {{
        ″id″: ″FILE<n>″,
        ″title″: ″<title>″,
        ″summary″: <summary>″, // A brief description of the file,
surfacing specific useful details when relevant.
For each topic in the above format, select one to two files that best capture
the topic, or would be most useful for a newcomer.”
```

In some implementations, continuing with the working example above, the folder summary request for the folder “Lunar project” can include the aforementioned statistics data for the folder, in addition to the subset of files. In this case, the folder summary request can be formatted, for instance, as follows:

```
{
  ″total_file_count″: 33,
  ″file_type_counts″: {
    ″Document″: 15,
    ″Sheet″: 12,
    ″PDF″: 6,
    ″Image″: 0
  },
  ″most_recent_edit″: ″3 days ago″,
  ″first_edit″: ″4 years ago″,
  ″files″: [
    {
      ″filename″: ″rocket_specs.pdf″,
      ″title″: ″Rocket Specs″,
      ″path″: ″Mission Documents > Design Specifications > Rocketry″,
      ″content″: ″This document details the specifications....″,
      ″modified″: ″2 weeks ago″,
      ″file_id″: ″FILE_0″
    },
    {
      ″filename″: ″lunar_module_design.docx″,
      ″title″: ″Lunar Module Design″,
      ″path″: ″Mission Documents > Design Specifications > Lunar
      Module″,
      ″content″: ″Lunar Module Design | The Lunar Module...″,
      ″modified″: ″5 weeks ago″,
      ″file_id″: ″FILE_1″
    },
    {
      ″filename″: ″landing_schedule.xlsx″,
      ″title″: ″Lunar Landing Schedule″,
      ″path″: ″Mission Objectives > Lunar Landing″,
      ″content″: ″Lunar Landing Schedule | A detailed timeline...″,
      ″modified″: ″2 weeks ago″,
      ″file_id″: ″FILE_2″
    },
  ]
Above is a selection of files from a folder. I would like you to create a
summary of this folder. Please summarize the folder in the following
format:
{{
  ″overview″: ″A one/two paragraph summary of the folder, including
overview, audience, file counts and types, and dates of recent activity.
This can be verbose and cite specific detail when appropriate.″
  ″key_topics″: [
    {{
      ″topic_title″: ″<title>″, // Short title of the topic
      ″topic_summary″: ″<summary>″, // Sentence or paragraph
summary of a key topic discussed above, citing files when appropriate.
This can be verbose and cite specific, useful details where appropriate.
      // Files relevant to this topic
      ″files″: [FILE_N, FILE_M] // IDs or useful, topical files
    }}
  ]
For each topic in the above format, select one to three files that best
capture the topic, or would be most useful for a newcomer.”
}}
```

It is noted that the folder summary request illustrated above is for the purpose of illustrations and is not intended to be limiting. As shown in this working example, the complex instruction can include an instruction portion (e.g., “For each topic in the above format, select one to three files that best capture the topic, or would be most useful for a newcomer.”) that customizes a folder summary based on a role of the user that provides the user input for folder summarization.

In other words, in some of the various implementations, the system generates the folder summary request based at least on the file content of the subset of files by: generating the folder summary request based further on metadata associated with a user of the user input for folder summarization.

In some of the various implementations, the rendered folder summary (see block 411) varies in dependence on the metadata associated with the user of the user input for folder summarization. For example, in some of the various implementations, the rendered folder summary includes a summary for one or more updates to the folder within a predefined period of time (e.g., since yesterday), in addition to the overall summary and in addition to the one or more key topics, dependence on the metadata associated with the user of the user input for folder summarization.

In various implementations, at block 411, the system processes the folder summary request, using a generative model, to generate a model output reflecting the folder summary.

In some of the various implementations, the system processes the folder summary request as input, using a generative model, to generate a model output indicating a plurality of folder summary candidates and a confidence score for each of the plurality of folder summary candidates. The system can process a portion of the model output that corresponds to a folder summary candidate having a highest confidence score, to generate content of the folder summary.

In various implementations, at block 413, the system causes the folder summary to be rendered (e.g., visually and/or audibly) via the client device (or another computing device), e.g., in response to the user input for folder summarization.

As a non-limiting example, the rendered folder summary can be as follows:

“This folder contains this year's marketing plans for product A.
It contains 89 files, mostly documents and PDFs. It also contains 5
subfolders and 4 images.
The key topics of the folder include:

| | |
|---|---|
| • | Project X: project X is the latest marketing campaign centered |
| | around key launches for our costume line. Project X is set to |
| | deliver in July. |
| | ◯ Key files: file_1 (link_1), file_2 (link_2) |
| • | Annual budget: This year's budget will be leaner than last year. |
| | Folks should prioritize team training. |
| | ◯ Key files: file_4 (link_4) |
| • | Project Y: Project Y is our mission to revolutionize the dog treat |
| | world! |
| | Our treats are packed with high-quality, wholesome ingredients, |
| | designed to support dog health and happiness. |
| | ◯ Key files: file_17 (link_17)” |

In some implementations, optionally, the system can further generate one or more topic suggestions (e.g., 290B in FIG. 2A), e.g., based on one or more groups of files (that may still be high ranked) that are not selected to form the subset of the files representing the folder. For instance, in the non-limiting example right above, the system can generate a first topic suggestion, e.g., “What are our goal this year?”, e.g., based on a particular group of files that is clustered/divided from the folder and that is not selected to form the subset of files representing the folder. The system can cause the first topic suggestion to be rendered (e.g., with respect to the folder summary (e.g., “This folder contains this year's marketing plans for product A. It contains 89 files, mostly documents and PDFs. It also contains 5 subfolders and 4 images. The key topics of the folder include: . . . ”, as a particular selectable GUI element. The particular selectable GUI element can be selected, and when selected, can cause a group file summary summarizing files from the aforementioned particular group of files to be rendered. The group file summary can be generated, for instance, based on processing content of files within the particular group of files, using a generative model.

In some of the various implementations, optionally, the user input at block 401 can include a key word (or a key term) identifying a particular type of files (or a particular type of content, or a particular range of files) to be summarized. For instance, the user input can be, “Based on this folder, summarize all customer interviews for project A”. In this case, the aforementioned subset of files processed (e.g., using the generative model) to generate the folder summary can be further selected based on the key word (or the key term) in the user input. Correspondingly, the generated folder summary can be in the following format:
“The themes that emerged from the customer interviews for Project X are:
   Health is Top Priority: most respondents expressed a clear desire for healthier options and transparent ingredients. (sources: file_1, file_5)
   Flavor Matters: even healthy treats need to be tasty enough. (sources: file_8).”
      Or as follows:
“The themes that emerged from the customer interviews for Project X are:
   Health is Top Priority: most respondents expressed a clear desire for healthier options and transparent ingredients. (sources: file_1, file_5).
   Flavor Matters: even healthy treats need to be tasty enough. Sources: file_1, file_5, file_8.”

As another example, the user input can be, “Catch me up on the project Y”, which corresponds to a request to summarize files updated for the folder. In this case, the system can determine a predefined period of time (e.g., a default period such as “since yesterday”, “within 7 days”, etc.), and aforementioned subset of files (e.g., processed to generate the folder summary using the generative model) can be further selected based on the predefined period of time. In this case (or even if the user input neither explicitly nor implicitly requests an update), the folder summary can include (or otherwise reflect) an overview of updates to the folder, where the key topics are determined based on the updates (or otherwise reflecting the updates). Correspondingly, the generated folder summary can have the following content:
“There are five files added to the folder, with 20 new comments and input from Lori, Jan, Sue, and others (click to view the complete list). Here are the top updates on Project Y since yesterday:
   Chicken is the flavor the team wants to prompt: Lori and Jan discussed which flavor of the dog treats should be featured in the campaign. They aligned on chicken based on the latest user feedback. (sources: file_1).
   Budget: This year's budget will be leaner than last year. Sue said in the all-hands that priorities should be team training and new product shots (sources: video_1).
   You need to update the budget with the latest vendor quotes: Jan commented and assigned you a task to update the budget with the latest vendor quotes that came in on Monday (view comment, add to task)”

It is noted that, in the above example, the folder summary can include an action (generated and suggested by the virtual assistant) to be performed (e.g., “view comment” which can be presented as a selectable GUI element that, when selected, causes a corresponding file to be opened in a particular status where the comment from Jan is displayed, this enables the user to easily perform a task of updating the budget). By including the selectable GUI element (e.g., “view comment”) for an action to be performed in the folder summary, not only the user can conveniently perform a corresponding task (e.g., update the budget), but computational resources associated with locating the file to be edited/updated can be saved or reduced.

It is noted that, while the techniques described above mostly apply to generate a structured summary for content of (or update to) a folder, techniques described herein can be applied to generate a structured summary for content of (and/or update to) a file. For example, given a user query of “Tell me about this file”, a structured summary for a file can be as follows:
“This file is about the marketing proposal for project X, which prioritizes logistics companies, manufacturing and surveying.
Since yesterday, there have been 10 new comments by Lori, Leo and 3 others:
   You have one critical action item: Sam asked you to update the budget based on the latest quotes
   You have new replies to your comments. Here are the top three:
      1. Lori asked if . . . “

It is further noted that, the user input can identify more than one file (e.g., file_1 and file_2) that are stored within the folder and request an update to the more than one file. For instance, the user input can be, “Tell me about these files: file_1 and file_2”. In this case, the aforementioned techniques can be applicable to generate a summary such as:
“Chicken is the flavor the team wants to prompt: Lori and Jan discussed which flavor of the dog treats should be featured in the campaign. They aligned on chicken based on the latest user feedback. (sources: file_5).
Budget: This year's budget will be leaner than last year. Sue said in the all-hands that priorities should be team training and new product shots (sources: video_1).
You need to update the budget with the latest vendor quotes: Jan commented and assigned you a task to update the budget with the latest vendor quotes that came in on Monday (view comment, add to task)”

It is noted that various implementations of this disclosure provide a request for folder summarization as from a user input or a user request received via an input device (e.g., microphone, keyboard, touch screen, etc.). In some other implementations, the request for folder summarization can be a system request generated automatically (e.g., offline during nighttime).

It is noted that, while the folder summary for the folder are mostly illustrated to be in natural language content, the folder summary can include image content, video content, or other types of media content. For instance, given a folder that contains multiple architectural drawings and/or one or more design documents (slides, etc.), each portraying a constituent part (e.g., a floor plan for a respective room) of a larger building, a request to summarize the folder's contents could yield a folder summary that includes a first portion (“overview” portion) showing a synthesized architectural drawing of the entire building (e.g., with missing portions interpolated by the generative model). In this example, the folder summary can further include a second portion (e.g., “key topic” portion) showing key features of the building, and/or a third portion (e.g., “key file” portion) showing one or more key files (a drawing having a client's comment to revise, etc.). In this example, the folder summary can also include (so as to remind) actions to be performed by a user that requests folder summarization.

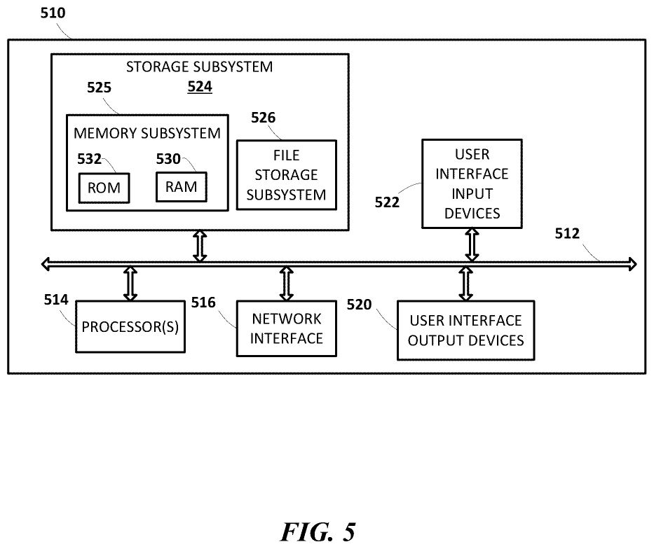

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

For example, in various implementations, a method implemented using one or more processors is provided. The method can include: receiving a request for folder summarization; identifying a folder to be summarized based on the request for folder summarization; identifying a plurality of files stored within the folder; selecting, from the plurality of files stored within the folder, a subset of files to represent the folder; generating a folder summary request based at least on file content of the selected subset of files; processing the folder summary request using a generative model to generate a model output reflecting a folder summary; and causing the folder summary to be rendered for folder summarization.

In some of the various implementations, selecting, from the plurality of files stored within the folder, the subset of files to represent the folder can include: generating a content embedding for each file from the plurality of files, the content embedding of a respective file numerically representing content of a respective file from the plurality of files; grouping, based on the content embedding for each file, the plurality of files into a plurality of file clusters, wherein each file cluster includes one or more files having a similarity satisfying a similarity threshold; and selecting one or more of the file clusters to form the subset of files selected from the plurality of files. In some of the various implementations, the content embedding of the respective file is generated based on processing file content, or a file summary, of the respective file using a text encoder. In some of the various implementations, the file summary of the respective file is generated based on processing file content of the respective file using the generative model or an additional generative model.

In some of the various implementations, the method further includes: determining metadata associated with a user who submitted the request. In some of the various implementations, generating the folder summary request based at least on the file content of the subset of files can include: generating the folder summary request based further on the metadata associated with the user who submitted the request. In some of the various implementations, selecting the subset of files to represent the folder is based at least on the metadata associated with the user who submitted the request.

In some of the various implementations, the folder summary varies in dependence on the metadata associated with the user who submitted the request. In some of the various implementations, the folder summary request includes an instruction to summarize updates to the folder that occurred within a predefined period of time, the predefined period of time being determined based on the metadata associated with the user indicating a most recent time the user accessed the folder. In some of the various implementations, the folder summary for the folder identifies one or more key files from the folder.

In some of the various implementations, the method further includes: determining metadata associated with one or more users having access to the folder, the metadata associated with the one or more users having access to the folder indicating user activities of the one or more users with respect to the folder or user relations between the one or more users.

In some of the various implementations, generating the folder summary request is further based on the user activities of the one or more users, or based on the user relations between the one or more users.

In some of the various implementations, the subset of files to represent the folder are selected based on the user activities of the one or more users, or based on the user relations between the one or more users.

In some of the various implementations, the method further includes: determining content associated with one or more of the user activities that alter one or more files within the folder. In this case, the folder summary for the folder can further include one or more actions suggested for a user who submitted the request for folder summarization based on the one or more of the user activities. In some of the various implementations, the folder summary for the folder includes an overview summarizing an update to the folder within a default period of time before receiving the request.

In some of the various implementations, selecting the subset of files to represent the folder is performed using a file selection model based at least on file content of the plurality of files within the folder and metadata associated with the folder. In some of the various implementations, the file selection model is a machine learning model trained to select one or more files from a given folder.

In some of the various implementations, the file content of the subset of files include a file summary for each file from the subset of files.

In various implementations, a computing system is provided. The computing system can include one or more processors, and one or more non-transitory computer readable media storing computer-readable instructions that when executed by the one or more processors cause the one or more processors to perform one or more operations. The one or more operations can include: receiving a request for folder summarization; identifying a folder to be summarized based on the request for folder summarization; identifying a plurality of files stored within the folder; selecting, from the plurality of files stored within the folder, a subset of files to represent the folder; generating a folder summary request based at least on file content of the selected subset of files; processing the folder summary request using a generative model to generate a model output reflecting a folder summary; and causing the folder summary to be rendered for folder summarization. Additionally, or alternatively, the one or more operations can include other steps or operations described elsewhere in this disclosure.

In various implementations, a non-transitory computer-readable media is provided. The non-transitory computer-readable media can store computer-readable instructions that, when executed by one or more processors, cause the one or more processors to perform one or more operations. The one or more operations can include: receiving a request for folder summarization; identifying a folder to be summarized based on the request for folder summarization; identifying a plurality of files stored within the folder; selecting, from the plurality of files stored within the folder, a subset of files to represent the folder; generating a folder summary request based at least on file content of the selected subset of files; processing the folder summary request using a generative model to generate a model output reflecting a folder summary; and causing the folder summary to be rendered for folder summarization.

1. A method implemented using one or more processors, the method comprising:
receiving a request for folder summarization;
identifying a folder to be summarized based on the request for folder summarization;
identifying a plurality of files stored within the folder, wherein selecting comprises:
generating a content embedding for each of the plurality of files, the content embedding of a respective file numerically representing content of a respective file from the plurality of files;
grouping, based on the content embedding for each file, the plurality of files into a plurality of file clusters, wherein each file cluster includes one or more files having a similarity satisfying a similarity threshold;
ranking the plurality of file clusters to generate a ranked list of file clusters;
selecting one or more of the file clusters to form the subset of files selected from the plurality of files;
selecting, from the plurality of files stored within the folder, a subset of files to represent the folder;
generating a folder summary request based at least on file content of the selected subset of files;
processing the folder summary request using a generative model to generate a model output reflecting a folder summary; and
causing the folder summary to be rendered for folder summarization.

2. (canceled)

3. The method of claim 1, wherein the content embedding of the respective file is generated based on processing file content, or a file summary, of the respective file using a text encoder.

4. The method of claim 3, wherein the file summary of the respective file is generated based on processing file content of the respective file using the generative model or an additional generative model.

5. The method of claim 1, further comprising:
determining metadata associated with a user who submitted the request;
wherein generating the folder summary request based at least on the file content of the subset of files comprises:
generating the folder summary request based further on the metadata associated with the user who submitted the request.

6. The method of claim 1, further comprising:
determining metadata associated with a user who submitted the request;
wherein selecting the subset of files to represent the folder is based at least on the metadata associated with the user who submitted the request.

7. The method of claim 1, further comprising:
determining metadata associated with a user who submitted the request;
wherein the folder summary varies in dependence on the metadata associated with the user who submitted the request.

8. The method of claim 1, further comprising:
determining metadata associated with a user who submitted the request;
wherein the folder summary request includes an instruction to summarize updates to the folder that occurred within a predefined period of time, the predefined period of time being determined based on the metadata associated with the user indicating a most recent time the user accessed the folder.

9. The method of claim 1, wherein the folder summary for the folder identifies one or more key files from the folder.

10. The method of claim 1, further comprising:
determining metadata associated with one or more users having access to the folder, the metadata associated with the one or more users having access to the folder indicating user activities of the one or more users with respect to the folder or user relations between the one or more users.

11. The method of claim 10, wherein generating the folder summary request is further based on the user activities of the one or more users, or based on the user relations between the one or more users.

12. The method of claim 10, wherein the subset of files to represent the folder are selected based on the user activities of the one or more users, or based on the user relations between the one or more users.

13. The method of claim 10, further comprising:
determining content associated with one or more of the user activities that alter one or more files within the folder,
wherein the folder summary for the folder further includes one or more actions suggested for a user who submitted the request for folder summarization based on the one or more of the user activities.

14. The method of claim 1, wherein the folder summary for the folder includes an overview summarizing an update to the folder within a default period of time before receiving the request.

15. The method of claim 1, wherein selecting the subset of files to represent the folder is performed using a file selection model based at least on file content of the plurality of files within the folder and metadata associated with the folder.

16. The method of claim 15, wherein the file selection model is a machine learning model trained to select one or more files from a given folder.

17. The method of claim 1, wherein the file content of the subset of files include a file summary for each file from the subset of files.

18. A computing system, comprising:
one or more processors;
one or more non-transitory computer readable media storing computer-readable instructions that when executed by the one or more processors cause the one or more processors to perform operations, the operations comprising:
receiving a request for folder summarization;
identifying a folder to be summarized based on the request for folder summarization;
identifying a plurality of files stored within the folder, wherein selecting comprises:
generating a content embedding for each of the plurality of files, the content embedding of a respective file numerically representing content of a respective file from the plurality of files;
grouping, based on the content embedding for each file, the plurality of files into a plurality of file clusters, wherein each file cluster includes one or more files having a similarity satisfying a similarity threshold;
ranking the plurality of file clusters to generate a ranked list of file clusters;
selecting one or more of the file clusters to form the subset of files selected from the plurality of files;
selecting, from the plurality of files stored within the folder, a subset of files to represent the folder;
generating a folder summary request based at least on file content of the selected subset of files;
processing the folder summary request using a generative model to generate a model output reflecting a folder summary; and
causing the folder summary to be rendered for folder summarization.

19. A non-transitory computer-readable media storing computer-readable instructions that when executed by one or more processors cause the one or more processors to perform operations, the operations comprising:
receiving a request for folder summarization;
identifying a folder to be summarized based on the request for folder summarization;
identifying a plurality of files stored within the folder, wherein selecting comprises:
generating a content embedding for each of the plurality of files, the content embedding of a respective file numerically representing content of a respective file from the plurality of files;
grouping, based on the content embedding for each file, the plurality of files into a plurality of file clusters, wherein each file cluster includes one or more files having a similarity satisfying a similarity threshold;
ranking the plurality of file clusters to generate a ranked list of file clusters;
selecting one or more of the file clusters to form the subset of files selected from the plurality of files;
selecting, from the plurality of files stored within the folder, a subset of files to represent the folder;
generating a folder summary request based at least on file content of the selected subset of files;
processing the folder summary request using a generative model to generate a model output reflecting a folder summary; and
causing the folder summary to be rendered for folder summarization.
